(19) United States
(12) Patent Application Publication
(10) Pub. No.: US 2018/0158139 A1
(43) Pub. Date: Jun. 7, 2018

(54) SYSTEM AND METHOD FOR ISSUING AND MANAGING FLEXIBLE LOANS

(71) Applicant: Kasasa, Ltd., Austin, TX (US)

(72) Inventors: Gabriel Krajicek, Austin, TX (US); Ben Morrison, Austin, TX (US); John Waupsh, Austin, TX (US); Diane Christensen, Round Rock, TX (US); Christopher Cohen, Austin, TX (US); Pradeep Ittycheria, Austin, TX (US)

(21) Appl. No.: 15/833,964

(22) Filed: Dec. 6, 2017

Related U.S. Application Data
(60) Provisional application No. 62/559,825, filed on Sep. 18, 2017.
(60) Provisional application No. 62/431,363, filed on Dec. 7, 2016.

(51) Int. Cl. G06Q 40/02; G06Q 30/06; G06Q 30/04; G06F 9/451

(52) U.S. Cl. CPC G06Q 40/025; G06F 9/451; G06Q 30/04; G06Q 30/06

(57) ABSTRACT

Systems and methods for issuing and managing flexible loans are described. Payments on such flexible loans may be applied according to a prescribed set of rules, and a borrower may be permitted to withdraw funds from a flexible loan account or skip a payment on the flexible loan account if one or more criteria are met.

### CROSS-REFERENCE TO RELATED APPLICATIONS

This application claims priority to U.S. Provisional Patent Application No. 62/431,363 filed Dec. 7, 2016 and to U.S. Provisional Patent Application No. 62/559,825 filed Sep. 18, 2017. The disclosures of each of the aforementioned applications are incorporated herein by reference.

### FIELD

The present disclosure relates generally to systems, methods, and computer program products which permit lenders to issue and manage flexible loans, and more particularly, to the issuance and management of loans by lenders to borrowers which permit the borrowers greater transparency and flexibility in managing and repaying the loans.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Consumers have many options for borrowing money from a funding source (lender), such as a financial institution or online lending entity, but generally only a line of credit or a credit card allows them to draw down a predetermined loan amount. Once a loan is requested and set up, consumers currently have limited control over monthly (or other periodic) payment amounts, the term of the loan, or the ability to use excess payments already paid on the loan amount.

A line of credit is typically used for a real estate or construction project, for example. A line of credit has a one-time end date when the full amount is due. Once the project is completed, the line of credit is usually either paid off or rewritten as a standard term loan or installment loan. A line of credit allows early payments, and draws against a predetermined fixed amount limit, but is not structured to permit recurring payments to pay down the borrowed amount (amortization schedule).

A credit card generally has a predetermined amount limit that allows a consumer to pay early, make excess payment amounts, and allows continued borrowing against the predetermined limit (similar to a line of credit). Extra or excess payments are applied to the balance, and often lower the monthly payment amount. Credit cards often have an expiration date, but only for the card, not the account balance. Consumers often do not know what the term end date is for the credit card balance, what the consequences of using the card are on payments or the payoff term, or what the consequences of making excess payments may have on the term to pay off the account balance. In other words, the credit card account holder has no insight into the impact of payments on the term or the overall costs of the loan.

Borrowers generally do not make payments larger than their periodic (usually monthly) repayment schedule dictates, even when they can afford to do so. This is because it has a negative impact on the consumer's access to liquidity. When the consumer makes extra payments or otherwise puts additional money against a scheduled payment, that extra money is kept by the lender, and, ultimately, applied to the account. This creates an unhealthy tension that the borrower feels when considering how to reduce his or her debt: paying more money into the loan is fiscally responsible, however, doing so limits the borrower's access to liquid funds in the case of a financial emergency. Consequently, most borrowers are reluctant to make excess payments on a loan under existing loan structures.

### SUMMARY

Some embodiments of the invention disclosed herein assist the consumer in understanding and paying down debts faster and by providing the consumer with liquidity without the fear of needing the funds later. For example, according to some embodiments of the present invention, the consumer has the ability to pay down a loan early, knowing if the funds are needed, they can draw against an early/extra payment amount or even skip a payment. Some flexible loans as described herein may give the consumer the capability to pay down debts faster by building in liquidity and flexibility options that serve to offset the consumer's concerns around the need for future funds. Further, according to some embodiments of the present invention, the consumer has some control over their borrowed liabilities and finances in that the consumer can monitor balances, make early payments or enter into other transactions, skip a loan payment, or make a withdrawal from available funds without having to make an extra trip to the funding source to do so or without having to ask the funding source for another loan.

According to some embodiments of the present invention, a funding source may provide a flexible loan to their customers that will allow excess payments and skipping payments, but which also ensures the loan terms are consistent with internal and regulatory controls. In some embodiments, funding sources may provide the flexible loan without any loss of potential interest revenue, and in some instances funding sources may need only monitor loan activity once a flexible loan is set up. If a consumer needs additional funds, the funding source may not need to authorize a new loan or rewrite a loan to allow skipping a payment or withdrawal of available funds.

In this description, the term “consumer” is frequently used to refer to a party that obtains a loan from a lender. It should be understood that a “consumer” in this context may be any type of borrower, whether an individual or an entity of any type (e.g., corporation, limited liability company, partnership, association, or the like). Similarly, the term “funding source” should be understood to mean a lender of any type, whether a bank, credit union, or otherwise.

In some embodiments, a flexible loan system or method may perform the following: calculating a Difference in Principal Balance value equal to a stated outstanding principal balance in the original amortization schedule for a specific period of time minus a current outstanding principal balance at that same specific period of time; calculating a Difference in Payments Made value equal to a sum of the payments received minus total payments expected at the specific period of time according to the original amortization schedule; determining the lesser value of the Difference in Principal Balance value and the Difference in Payments Made value; and permitting the borrower to withdraw funds up to the lesser value if the lesser value is a positive amount (hereafter referred to as an available to withdraw balance).

In some embodiments, a flexible loan system or method may perform the following: calculating a sum of the payments received during a payment window; and setting a status of not current for the borrower only if the sum of the payments received during the payment window is less than an installment amount due for the payment window per the original amortization schedule.

In some embodiments, a flexible loan system may comprise a processor and a memory in communication with the processor, the processor comprising a flexible loan module configured to receive consumer loan data for a consumer loan for a consumer from a loan origination system, the consumer loan data including a principal loan amount and payment terms including a payment schedule; the processor further comprising a consumer loan transaction module configured to receive transaction data from the consumer including a request to modify the payment terms of the consumer loan; the processor further comprising a consumer interface module configured to provide the consumer loan data for display on a visual display for the consumer and receive one or more modifications of the consumer loan data from the consumer; and the flexible loan module being further configured to provide modified consumer loan data representative of the one or more modifications to the consumer interface module suitable for display on the visual display in real time so that the visual display may depict a visual representation of the modified consumer loan data before the payment terms are modified.

In some embodiments, a flexible loan system may comprise a tangible, non-transitory computer readable medium comprising instructions executable by a computer for performing the following: receiving loan data pertaining to a flexible loan from a funding source to a consumer, the loan data comprising an original principal amount, an original periodic payment amount, an original term, and an original payoff date; receiving periodic payment amounts to be applied to the flexible loan; adjusting a remaining principal amount for the flexible loan based on the periodic payment amounts; displaying a first representation of the flexible loan for the consumer, the first representation comprising a representation of an original payment schedule for the flexible loan over the original term, including a representation of the original payoff date, a representation of a current date, a representation of a payment history for the flexible loan through the current date, and a representation of the remaining principal amount through a currently applicable payoff date; receiving from the consumer a first indication of a potential change to the flexible loan, the potential change being withdraw money; calculating an excess amount by which one or more payments made by the consumer on the flexible loan exceed a minimum payment amount; receiving a request from the consumer for a withdrawal in an amount less than or equal to the excess amount; and displaying a second representation of the flexible loan for the consumer, the second representation reflecting a change to at least one of the remaining principal amount and the currently applicable payoff date, the second representation illustrating the change versus the first representation; receiving from the consumer a second indication to make the potential change effective; authorizing the withdrawal in response to the request; and modifying the flexible loan in response to the second indication.

In some embodiments, a method for providing a flexible loan to a consumer, comprising: receiving consumer loan data for a flexible loan from a remote location and storing the consumer loan data; providing the consumer with access to the flexible loan through a user interface which provides a visual representation of the consumer loan data; providing the consumer with an option to indicate a modification to the flexible loan through the user interface; generating a visual representation of the modification via the user interface in real time; and incorporating the modification into the flexible loan only if the modification is authorized by the consumer.

In some embodiments, a method for evaluating a flexible loan to a consumer, comprising: providing the consumer with remote access to the consumer's stored flexible loan data; providing a visual representation of the flexible loan data in real time through a user interface; providing the consumer access to modify current payment terms of the flexible loan in real time; and generating a visual representation of current flexible loan data and modified flexible loan data through the user interface.

In some embodiments, a method of providing a flexible loan to a consumer based on an existing consumer loan, comprising: receiving and storing consumer loan data for an existing consumer loan; providing the consumer with access to the consumer loan data for the existing consumer loan through a user interface which provides a visual representation of the consumer loan data; providing the consumer with a flexible loan option to make a modification to payment terms of the existing consumer loan; processing the modification to the existing consumer loan and sending a visual representation of the modification to the consumer via the user interface in real time; and determining if the modification is permissible and incorporating the modification into the existing consumer loan only if the modification is determined to be permissible and is authorized by the consumer.

In some embodiments, a flexible loan system comprising a tangible non-transitory computer readable medium comprising instructions executable by a computer for performing the following: receiving loan data pertaining to a flexible loan from a lender to a borrower, the flexible loan having an original amortization schedule; receiving payments to be applied to the flexible loan, each of the payments having a payment amount; and applying each of the payments to the flexible loan in the following order of priority, regardless of when the payments are made, the amounts of the payments, and the source of the payments: (i) to interest accrued; (ii) to principal, if any, in an amount equal to an installment amount due per the original amortization schedule minus the interest accrued; (iii) to fees outstanding, if any; (iv) to additional principal, if any, in an amount equal to the payment amount minus an amount of the payment already applied per the (i), (ii), and (iii) priorities.

In some embodiments, a flexible loan system may comprise a tangible, non-transitory computer readable medium comprising instructions executable by a computer for performing the following: receiving loan data pertaining to a flexible loan from a funding source to a consumer, the loan data comprising an original principal amount, an original periodic payment amount, an original term, and an original payoff date; receiving periodic payment amounts to be applied to the flexible loan; adjusting a remaining principal amount for the flexible loan based on the periodic payment amounts; displaying a first representation of the flexible loan for the consumer, the first representation comprising a representation of an original payment schedule for the flexible loan over the original term, including a representation of the original payoff date, a representation of a current date, a representation of a payment history for the flexible loan through the current date, and a representation of the remaining principal amount through a currently applicable payoff date; receiving from the consumer a first indication of a potential change to the flexible loan, the potential change being a modification of the periodic payment amount; displaying a second representation of the flexible loan for the consumer, the second representation reflecting a change to at least one of the remaining principal amount and the currently applicable payoff date, the second representation illustrating the change versus the first representation; receiving from the consumer a second indication to make the potential change effective; authorizing the modification of the periodic payment amount in response to the request; and modifying the flexible loan in response to the second indication.

### BRIEF DESCRIPTION OF DRAWINGS

Novel features believed characteristic of the invention are set forth in the appended claims. The invention itself, however, as well as a preferred mode of use, and some objectives and advantages thereof, will best be understood by reference to the following detailed description of an illustrative embodiment when read in conjunction with the accompanying drawings, wherein:

FIG. 1 illustrates a networked computer environment, according to some embodiments of the present invention.

FIG. 2 is a block diagram of a computer system suitable for systems shown in FIG. 1, according to some embodiments of the present invention.

FIG. 3 is a block diagram of a flexible loan computer system, according to some embodiments of the present invention.

FIG. 4 is an example flexible loan system initial user interface, according to some embodiments of the present invention.

FIG. 5 is an example flexible loan system user interface depicting the effect on a flexible loan responsive to a periodic (in this case, monthly) payment adjustment, according to some embodiments of the present invention.

FIG. 6 depicts the flexible loan system user interface of FIG. 5 responsive to a consumer committing to a monthly payment adjustment, according to some embodiments of the present invention.

FIG. 7 is an example flexible loan system user interface depicting the effect on a flexible loan responsive to withdrawing excess payments, according to some embodiments of the present invention.

FIG. 8 illustrates computer system based actions in the computing environment of FIGS. 1 through 3, according to some embodiments of the present invention.

FIG. 9 is a schematic diagram of a flexible loan system.

FIG. 10 is a schematic diagram of a new loan application process.

FIG. 11 is a sample screen of a user interface of a flexible loan system illustrating data for a flexible loan.

FIG. 12 is another view of the user interface of FIG. 11.

FIG. 13 is another sample screen of the user interface of FIG. 11 illustrating confirmation of a one-time payment.

FIG. 14 is a flowchart illustrating a payment methodology for a flexible loan system.

FIG. 15 is a schematic diagram illustrating a fee methodology for a flexible loan system.

FIG. 16 is a schematic diagram illustrating payment processing for a flexible loan system.

FIG. 17 is a schematic diagram illustrating processing of a payment made with an internal checking account.

FIG. 18 is a schematic diagram illustrating processing of a payment made in a branch of a financial institution.

FIG. 19 is another view of the user interface of FIG. 11 illustrating a Take Money Back (withdraw available funds) selection.

FIG. 20 is another sample screen of the user interface of FIG. 11 illustrating confirmation of a withdrawal.

FIG. 21 is a flowchart illustrating a withdrawal methodology for a flexible loan system.

FIG. 22 is a schematic diagram illustrating withdrawal processing in a flexible loan system.

FIG. 23 is a schematic diagram illustrating general ledger updates for a flexible loan system and a participating financial institution.

FIG. 24 is a schematic diagram illustrating payment windows for a flexible loan.

FIG. 25 is a schematic diagram illustrating a term loan with a savings account for a flexible loan system.

FIG. 26 is a schematic diagram illustrating a term loan with an associated line of credit for a flexible loan system.

FIG. 27 is a schematic diagram illustrating a components architecture that may be used in some embodiments of a flexible loan system.

FIG. 28 is a schematic diagram illustrating technologies that may be used to deploy the components architecture in FIG. 27.

FIG. 29 is a flowchart illustrating some embodiments of flexible savings loan initiation.

FIG. 30 is a flowchart illustrating some embodiments of information exchange between components for creating a loan and disbursing funds for the loan.

FIG. 31 is a flowchart illustrating some embodiments for making a one-time payment for a consumer.

FIG. 32 is a flowchart illustrating some embodiments for making a recurring loan payment for a consumer.

FIG. 33 is a flowchart illustrating some embodiments for making a withdrawal payment to a consumer.

FIG. 34 is a flowchart illustrating a process for recurring payments.

FIG. 35 is a flowchart illustrating a process for withdrawals.

### DETAILED DESCRIPTION

Detailed embodiments of the present invention are disclosed herein to illustrate claimed systems, structures, methods, and computer program products. This invention may, however, be embodied in many different forms and should not be construed as limited to the exemplary embodiments disclosed herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

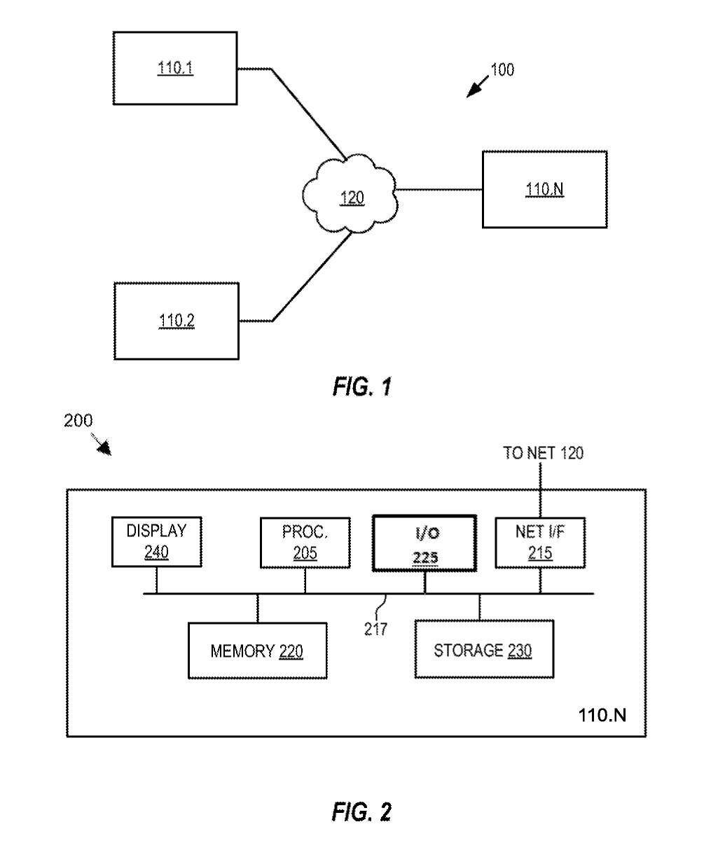

FIG. 1 illustrates an example computing and network communication environment 100, according to some embodiments of the present invention. As shown, environment 100 may include computer systems 110.1, 110.2 through 110.N which may be connected via one or more communication networks 120. Systems 110.1, 110.2, etc. may include modules, which may be computer program or hardware modules, configured to perform tasks for their own respective systems or for other systems or both. In various instances, message communication via networks 120 may include communication via protocols for packet data, email, instant message, text message or proprietary protocols, for example.

FIG. 2 illustrates details of a computer system 200 suitable as computer systems 110.1, 110.2, etc. according to some embodiments of the present invention, wherein system 200 may include at least one central processing unit (CPU) 205, network interface 215, interconnect (i.e., bus) 217, memory 220, input/output (I/O) device 225, storage device 230, and display 240. CPU 205 may retrieve and execute programming instructions stored in memory 220 for applications. Similarly, CPU 205 may retrieve and store application data residing in memory 220. Interconnect 217 may facilitate transmission of data, such as programming instructions and application data, among CPU 205, storage 230, network interface 215, and memory 220. CPU 205 is representative of a single CPU, multiple CPUs, a single CPU having multiple processing cores, and the like. Additionally, memory 220 is representative of a random-access memory, which may include data and program modules for run-time execution, for example, according to some embodiments of the present invention. It should be understood that system 200 may be implemented by other hardware and that one or more modules thereof may be firmware.

Some embodiments of the present invention may be a system, a method, and/or a computer program product. The computer program product may include a tangible, non-transitory computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device may receive computer readable program instructions from the network and forward the computer readable program instructions for storage in a computer readable storage medium within the respective computing/processing device.

The computer readable program instructions may execute entirely on the user's computer, partly on the user's computer, as a stand-alone software package, partly on the user's computer and partly on a remote computer or entirely on the remote computer or server. The flexible computer system may be configured for a client/server environment or a “software as a service” (“SaaS”) environment. In the latter scenario, the remote computer on which the computer readable instructions and databases (or links to databases) reside may be connected to the user's computer through a variety of communications networks, including a local area network (LAN) or a wide area network (WAN), or the connection may be made to an external computer (for example, through the Internet using an Internet Service Provider). Aspects of some embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

One or more databases may be included in a flexible loan system for storing and providing access to data for the various implementations. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption and the like.

The database may be any type of database, such as relational, hierarchical, object-oriented, and/or the like. The database may be organized in any suitable manner, including as data tables or lookup tables.

Association of certain data may be accomplished through any data association technique known and practiced in the art. For example, the association may be accomplished either manually or automatically.

The host may provide a suitable website, other internet-based graphical user interface accessible by users, or a set of Application Programming Interfaces (“APIs”) for others to build a software interface for users. The term webpage as it is used herein is not meant to limit the type of documents, APIs and applications that might be used to interact with the user. For example, a typical website might include, in addition to standard HTML documents, various forms, Java applets, Javascript, active server pages (ASP), Java Server Pages (JSP), common gateway interface scripts (CGI), extensible markup language (XML), dynamic HTML, cascading style sheets (CSS), helper applications, plug-ins, and the like.

A typical loan processing environment may include a variety of systems that support various functionality associated with the origination, underwriting, processing, and servicing of loans. For example, one or more loan origination systems may be provided as part of a loan processing environment and may support functionality for performing initial origination processing associated with an application for a loan. In addition, one or more loan servicing systems may be provided as part of a loan processing environment and may support functionality for managing various attributes or characteristics of a loan over the duration of the loan. Moreover, various third party systems may be provided to support functionality for performing a variety of types of processing associated with loans such as, for example, processing to determine a loan applicant's credit-worthiness, processing to determine compliance with applicable regulatory requirements, and so forth.

In some embodiments, a flexible loan system and method disclosed herein may provide a web-based loan processing environment that allows consumers receiving an installment loan to make an extra payment, skip a payment, or withdraw excess payment funds. The system may provide a visual, haptic, audio, or other user interface (or combination thereof) on the user access computer, mobile device, or other device that enables the consumer to start the process to make a payment that is more or less than the installment amount and transparently visualize or otherwise understand the impact to the loan payoff date and interest charges prior to committing to a proposed transaction. For flexible loans funded by a depository financial institution, the flexible loan may be tied to another account (a deposit account, for example) at the same financial institution providing funding, wherein the user may receive special incentives or rewards between the two accounts and whereby the funding source may have access to both accounts for better monitoring and tracking, thereby reducing the funding source's liability risks. Additionally, the flexible loan may be tied to another account (a deposit account, for example) at a different financial institution within a network of financial institutions, to provide similar incentives and accessibility to the linked accounts, across a number of like-minded funding sources or depository financial institutions. Further, the consumer seeking such a loan may obtain funding from multiple funding sources (also known as pooled or multi-tenant loan funding) for larger loan needs.

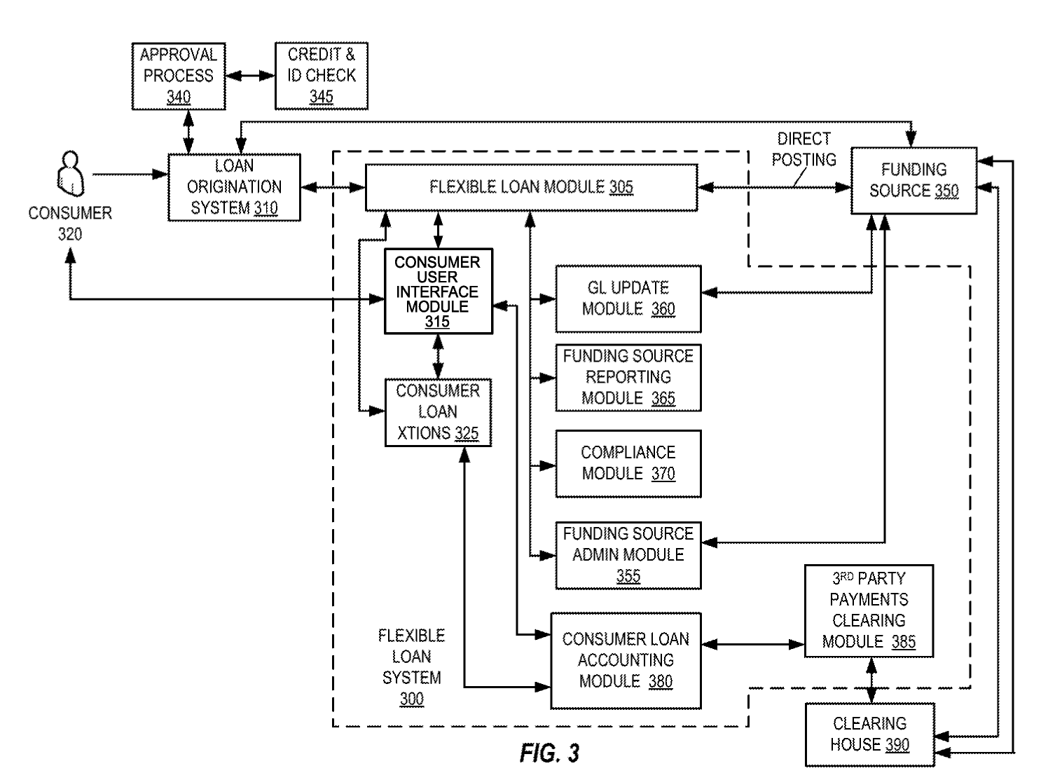

Referring now to FIG. 3 together with FIGS. 1 and 2, aspects of a flexible loan system 300 (sometimes referred to herein as FLS 300) are illustrated, according to an embodiment of the present invention. Flexible loan system 300 may include modules for managing interactions between a consumer 320, a flexible loan module 305, a funding source 350, and an affiliated general ledger (“GL”) such as a core processing system or other account management database, and a direct posting connection or a clearing house for payments reconciliation between a funding source and a consumer loan account.

Flexible loan module 305 may communicate with a funding source 350 internal core processor, a third-party processor, or a processor within funding source 350 to manage loan payments to/from an account within funding source 350 or to/from another source over a communications funds transfer network, an automated clearing house or direct link to funding source 350, for example. Loan data may be transmitted by file transfer protocol or by API or other integration methods.

In some embodiments, consumer 320 may access flexible loan system 300 in a pre-funding phase through a communications network, such as the Internet or a cellular network, for example, via a user device, such as a personal computer or mobile device, interacting with flexible loan system consumer interface module 315. Upon using consumer interface module 315, consumer 320 may be redirected to a flexible loan application hosted at flexible loan module 305, consumer interface module 315, or via a loan origination system 310. A suitable commercially available loan origination software is Baker Hill Origination® licensed by Baker Hill Solutions, LLC.

Next, flexible loan module 305, consumer interface module 315, or a loan origination system 310 may display a fillable flexible loan application form to consumer 320 or otherwise receive data input into a flexible loan application form, which may include but is not limited to consumer name, address, contact information, amount to borrow, annual income, and existing debt load, for example. For a flexible refinance loan, consumer 320 loan data entry may additionally include existing loan number, original and current balance, original and current due date of loan, current payment amount and due date of payment, and interest rate, for example.

Data entered by consumer 320 may be transmitted over a communication network, such as network 120 in FIG. 1, to both flexible loan module 305 and loan origination system 310. The data may be transmitted directly to flexible loan module 305 via consumer interface module 315 and then provided to loan origination system 310 or alternatively transmitted to loan origination system 310 and then ultimately directed to flexible loan module 305 from loan origination system 310.

Responsive to loan application data received from consumer 320 as described above, and funding source 350 reviewing credit and identity verification data from credit and identity verification system 345, funding source 350's loan approval process 340 may approve or reject the loan application and, if approved, determine loan terms for transmittal to flexible loan module 305 for presentation to consumer 320 at consumer interface module 315.

Responsive to consumer 320 accepting an authorized flexible loan and terms through consumer interface module 315, flexible loan module 305 may initiate loan funding by creating a debit transaction to funding source 350 and a credit transaction to consumer 320, or funding source 350 may fund directly to consumer 320.

In the pre-funding phase, and once a loan request has been accepted by a funding source 350, the consumer 320 may be presented with flexible loan options that may include:

Flexible Loan with Variable Balance
a. Excess payments are applied to principal balance and loan principal balance is adjusted accordingly
b. Withdrawal of excess payments is applied against principal balance of loan and balance is adjusted accordingly

Flexible Loan with Withdrawal Capabilities
a. Excess payments are applied to the flexible loan principal balance and loan principal balance is adjusted accordingly
b. Accumulated excess payments less any interest due are reflected in an amount available for consumer withdrawal
c. Withdrawals from excess payment balance are applied to the flexible loan balance outstanding and deducted from available to withdraw balance. Interest rate on newly adjusted balance=interest rate on flexible loan

Flexible Loan with Affiliated or Attached Deposit Account
a. Excess payments are deposited into attached deposit account
b. Accumulated excess payments are reflected in deposit account balance
   Where interest rate on deposit account is similar to the interest rate on loan
   Where the excess payments are the only deposits in the deposit account
   Where interest or other rewards earned by deposit account can be applied to flexible loan principal balance

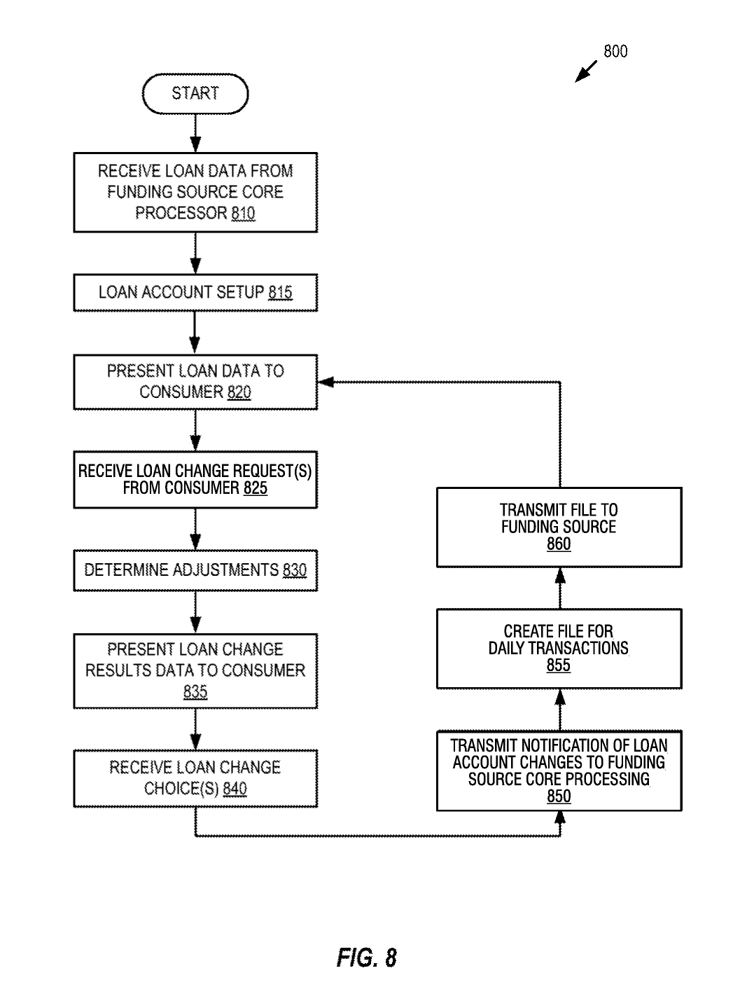

With reference now to FIGS. 3 and 8, computer system based actions in the computing environment of flexible loan system 300 are illustrated. Responsive to flexible loan option selection by funding source 350 and/or consumer 320, the flexible loan module 305 may receive and accept the loan terms 810 from the funding source 350 and create an initial flexible loan account 815, including storing loan account data, in storage 230 of FIG. 2, for example. Flexible loan module 305 may next proceed to monitor, manage, and interact with consumer 320 as described in more detail herein below.

Other modules may be provided by system 300 for managing processes and communications between or among consumer 320, flexible loan module 305, funding source 350, and direct GL host or clearinghouse 390, including:
Loan transactions module 325 for managing loan payments and withdrawals
GL update module 360 for settlement of funds for funding source 350
Funding source reporting module 365 for historic and current transaction information for use by funding source 350 or consumer 320
Compliance module 370 for creating and transmitting required disclosures and regulatory forms to funding source 350 for regulatory filing
Funding source administration module 355 for providing a funding source user interface where loan officers, for example, may monitor and adjust a funded flexible loan.
Consumer loan accounting module 380 for storing loan terms
Third party payments clearing module 385 for settlement of funds

Consumer 320 may access their flexible loan regardless of where funding has occurred. In some embodiments, the flexible loan may appear to the consumer 320 branded by the servicing or originating FI while the loan asset is held at a different FI. Flexible loan module 305 may present loan data 820 to consumer 320 at consumer interface module 315, which may include transaction data received from consumer loan transaction module 325. Flexible loan data 820 presented to consumer 320 may include loan history, loan activity to date or month to date, loan term, payments and excess funds available for each flexible loan the user maintains at one or more networked, yet potentially competitive, funding sources.

Flexible loan module 305 may collect data for all loan activity for enhancing user experience; improving analytical models, machine learning or other loan adjudication and conditioning; refining marketing tactics; and/or presentation to consumer 320 for decision making. Consumer 320 may use such data for determining, for example, the difference in paying off a loan faster vs placing the funds into a savings account. Sample loan activity data collected by flexible loan module 305 and presented to Consumer 320 may include:
a. Loan-to-date and projected data until end of term if the consumer continues with a current periodic or excess payment amount;
b. Adjusted loan-to-date and projected data if the consumer requests a new periodic payment, extra payment, skipped payment, or withdrawal;
c. Dollar amount of extra contributions in excess of minimum payments;
d. Number of payments avoided;
e. Interest amount avoided;
f. Interest earned if extra payments are placed in a savings account.

Consumer 320 may next interact with flexible loan module 305 via consumer interface module 315 to determine the effect of making a payment, skipping a payment, or withdrawing from the excess payment funds, thus determining the impact to the loan payoff date and interest charges. For example, responsive to receiving a request 825 from consumer 320 to modify or adjust a flexible loan, flexible loan module 305 may receive reference database information from either the loan transactions module 325 or directly from the funding source 350 processor on available balance for withdrawal, determine adjustments 830 results for various withdrawal or payment amounts, and present data 835 to the consumer indicating the effect on loan terms if consumer 320 skips a payment, makes an extra payment, makes an excess payment, and other results for various withdrawal or payment amounts. Then, if desired, consumer 320 may choose to initiate loan adjustments via consumer loan interface module 315 by, for example, clicking on the actions for transmittal to flexible loan module 305, including but not limited to, for example:
i. Withdraw Money;
ii. Make a one-time Extra Payment;
iii. Schedule a Skip Payment;
iv. Change Periodic (in this example, Monthly) Payment amount. The frequency of the periodic payments (e.g., hourly, daily, weekly, bi-weekly, monthly, bi-annually, annually, date-defined, or the like) may also be adjusted by the borrower or the lender.

In some embodiments, flexible loan module 305 may not allow consumer 320 to create an activity outside of the terms of the loan, nor beyond their available balance to withdraw. Available balance to withdraw may be, for example, the original amortization amount at that time in the term of the loan less balance remaining on loan less interest and/or fees due to funding source 350. In some embodiments, funding source 350 may extend additional credit to consumer 320 via the amount available for withdrawal, e.g., if a collateralizing asset has increased in value, which may or may not increase the term of the flexible loan.

Responsive to receiving loan change choices 840 for a consumer-selected loan adjustment i, ii, or iii, above, for any choices 840 that affect loan balances, flexible loan module 305 may create a transaction for transmittal to funding source 350 in real time or in batches, adjust ledgers via posting files, record transaction information via changes to distributed ledgers (such as blockchain, for example), or otherwise trigger an appropriate movement of funds. Responsive to receiving a consumer selected loan adjustment iv, above, as at choices 840, flexible loan module 305 may create and transmit a notification 850 to funding source 350. Further, flexible loan module 305 may use legal authorization templates stored in compliance module 370 and create any legally required notifications such as the consumer authorization to change the amount of a payment.

In some embodiments, consumer 320 may set up payments to be automatically deducted, as described herein below. In such embodiments, flexible loan module 305 may receive an automatic payment request from the consumer's deposit account at funding source 350 or some other source. Consumer loan transaction module 325 and consumer loan accounting module 380 may save this request as an authorization and change the next periodic payment amount to be deducted via third party payments clearing module 385. Then, flexible loan module 305 may create a file for daily transactions 855 which, for example, may be a National Automated Clearing House Association (NACHA) formatted file of all that day's transactions. Funding source 350 may either log into the flexible loan module 305 via funding source administration module 355 to retrieve the file, or the file may be transmitted 860 to funding source 350 for processing through funding source 350's core processor. The next day the process may begin again. Transactions completed through flexible loan module 305 may be real time, but funding source 350's balances may not reflect the transactions until the next business day (after normal funding source 350 daily processing), for example. Of course, transactions and account updating may occur on any suitable schedule, including real time, and may not necessarily be on a daily basis.

Flexible loan system 300 may include multi-tenant loan origination, according to some embodiments of the present invention, which may allow multiple financial institutions, such as depository banks or credit unions, to participate as loan funding organizations by using any loan origination system. In some embodiments, loan origination system 310 may include multiple funding sources, e.g., multiple banks and/or credit unions, using a single loan origination system, such as Lend-X Automatic Decision Engine licensed by LendingTree, LLC of Charlotte, N.C., for example. A multi-tenant flexible loan system 300 may include an additional loan review module for managing interactions between or among consumer 320, flexible loan module 305, multiple funding sources 350, GL update module 360, and/or clearing house 390, for example. Alternatively or additionally, systems and methods described herein may involve multiple funding sources 350 and multiple loan origination systems 310, wherein each funding source 350 uses a loan origination system 310 that is in communication with flexible loan system 300.

Referring now to FIGS. 3-7, an example embodiment is described from the point of view of consumer 320 interaction with flexible loan system 300, which may be via consumer interface module 315 or loan origination system 310, for example.

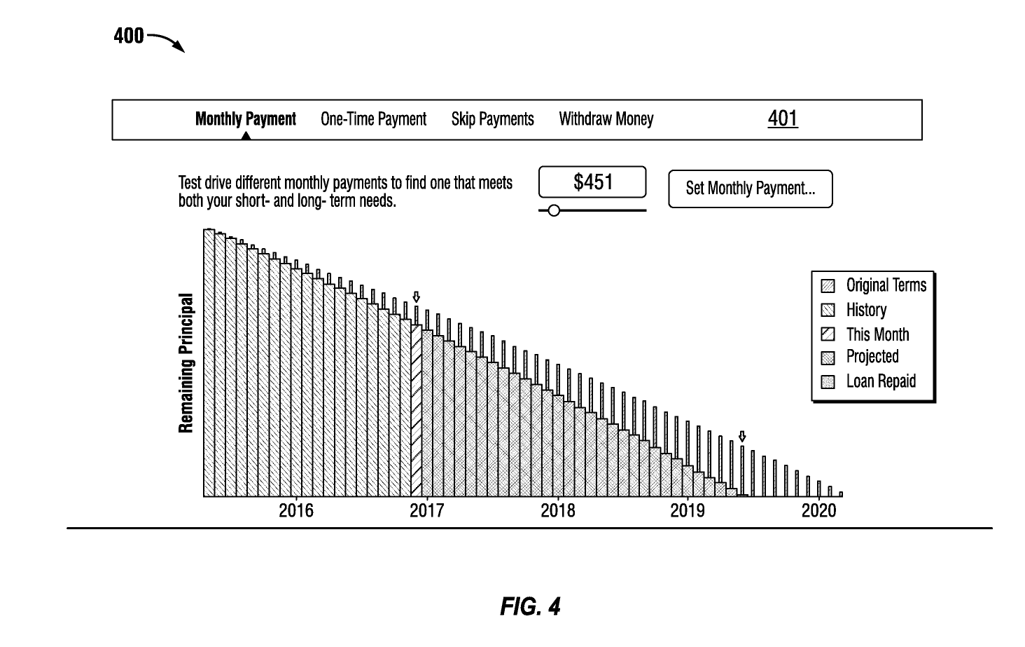

FIG. 4 depicts a user interface 400 of consumer interface module 315 presenting consumer 320's initial flexible loan data, including an initial periodic (in this case, monthly) payment amount of $451 and a graph showing the remaining loan principal over the term of the loan. From menu 401, consumer 320 may select the following for adjustment:
1. Change the periodic loan payment amount;
2. Make a one-time payment;
3. Skip a payment;
4. Withdraw excess money.

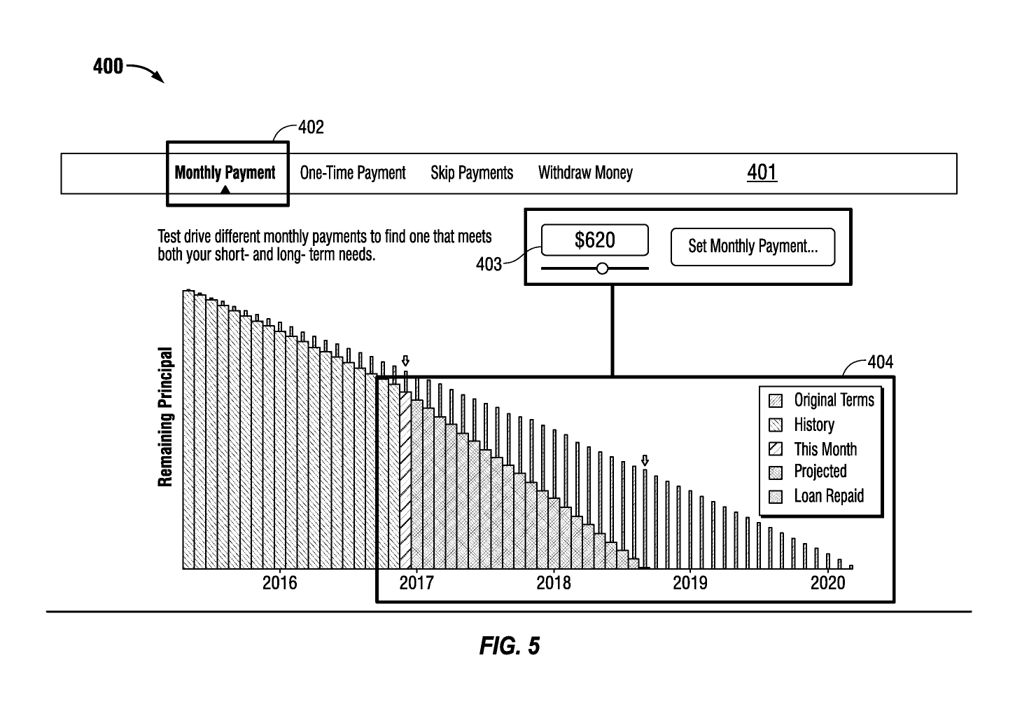

FIG. 5 depicts the user interface 400 after consumer 320 has decided to check the effect on their flexible loan if they adjust the periodic payment by clicking the (in this case) Monthly Payment option 402 from menu 401 and entering or otherwise indicating a value of $620 for the new periodic payment amount in data entry box 403. Responsive to receiving the adjustment in data entry box 403, flexible loan module 305 may determine loan adjustments for presentation to consumer 320 as shown in FIG. 5. Preview box 404 highlights the effect of the change in periodic payment amount on the remaining principal and payoff date for consumer 320, i.e., the impact to consumer 320's existing flexible loan as a result of the change. User interface 400 may adjust to reflect the changes prior to consumer 320 actually setting the change. In this example, consumer 320 adjusted their monthly payment from $451 to $620 per month, and user interface 400 reflects the impact that such an adjustment would have on the remaining principal and payoff date versus the original loan payment schedule in preview box 404 (e.g., in this example, the GUI displays a graphical representation of how the loan would be paid off sooner than the original amortization schedule, assuming no further adjustments were made).

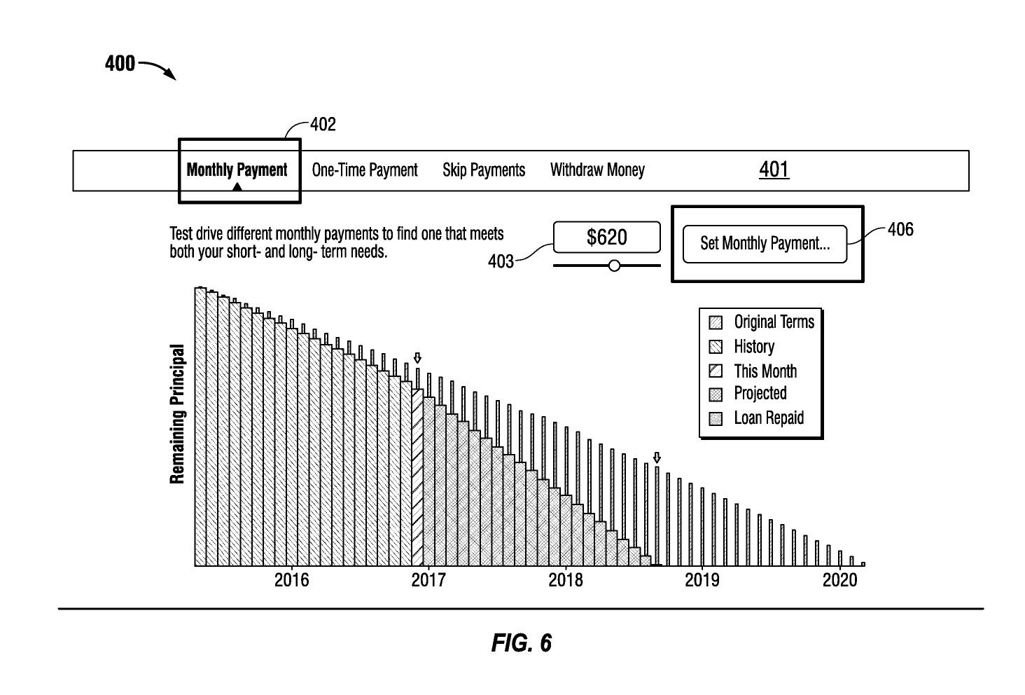

FIG. 6 depicts user interface 400 when consumer 320 commits to an adjustment. In this case, consumer 320 decides to commit to change the flexible loan monthly payment from $451 to $620 by clicking on the Set Monthly Payment action button 406. Upon receiving the Set Monthly Payment request, flexible loan module 305 may create and send a file to funding institution 350's core processor that reflects the change consumer 320 chose to make.

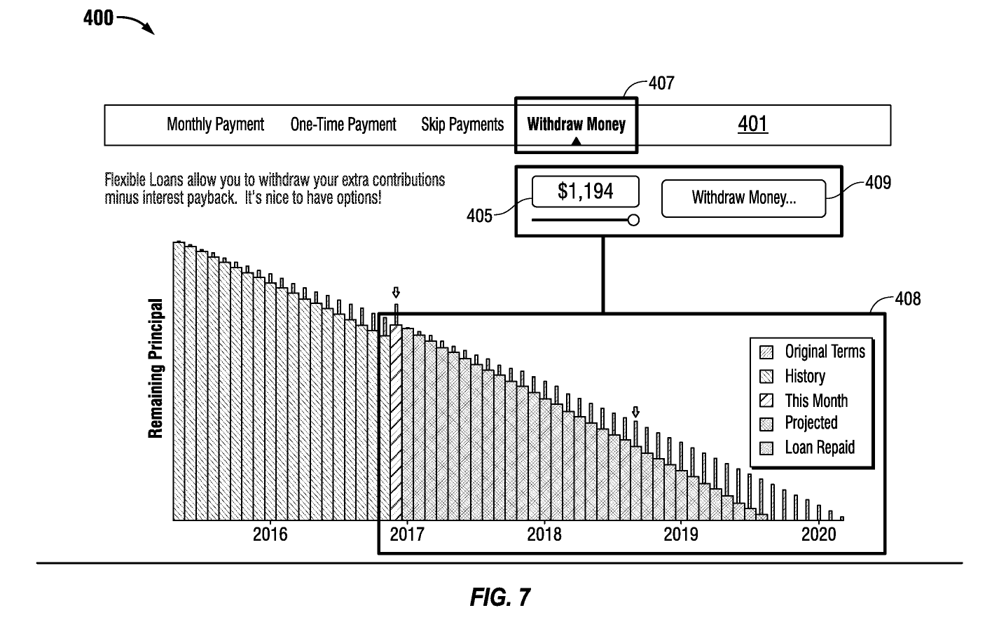

FIG. 7 depicts user interface 400 after consumer 320 has decided to check the effect on their flexible loan if they withdraw excess payments from their flexible loan, by clicking the Withdraw Money option 407 from menu 401 and entering a value of $1,194 as an amount to withdraw in data entry box 405. Responsive to receiving the proposed withdrawal amount, flexible loan module 305 may calculate the impact of such withdrawal on the loan, determine loan adjustments, and present the results to consumer 320. Preview box 408 highlights the effect of the adjustment on the remaining principal and payoff date. Responsive to consumer 320 clicking the Withdraw Money action button 409, flexible loan module 305 may create a file representative of the changes for transmittal to funding source 350. Funding source 350 may then move the requested amount ($1,194 in this example) into consumer 320's designated deposit account, for example. In some embodiments, the periodic payment amount may change if the borrower makes such a change, and the revised periodic payment amount may remain unless and until the borrower makes a further change to it. In some embodiments, the term of the loan may be shortened due to making of extra payments or extended due to withdrawal of available amounts only up to (but not beyond) the original payoff date per the original amortization schedule.

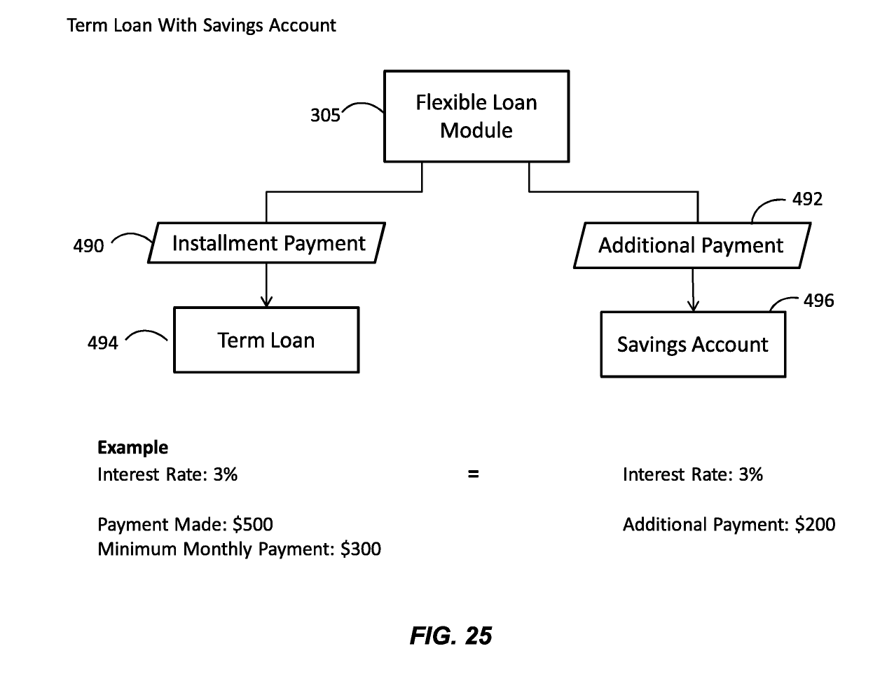

FIG. 25 depicts Flexible Loan Module 305 with savings account 496 as one embodiment for a flexible loan with an affiliated or attached deposit account. For the term loan 494 with savings account 496, when an installment payment 490 is made through flexible loan system 300, the minimum installment payment may be applied to term loan 494 and any additional funds paid beyond the minimum installment payment may be sent to savings account 496, which may have the same interest rate as term loan 494. For example, an installment payment of $500 made to term loan 494 at a three percent interest rate with a minimum installment payment of $300 within Flexible Loan Module 305 may be allocated as a $300 minimum installment payment to term loan 494 and an additional payment 492 of $200 into savings account 496 with a three percent interest rate. Of course, in other embodiments, term loan 494 and savings account 496 may have different interest rates. In this example, the extra $200 paid into savings account 496 may be available for the borrower to withdraw much like an available to withdraw balance as described herein for other embodiments.

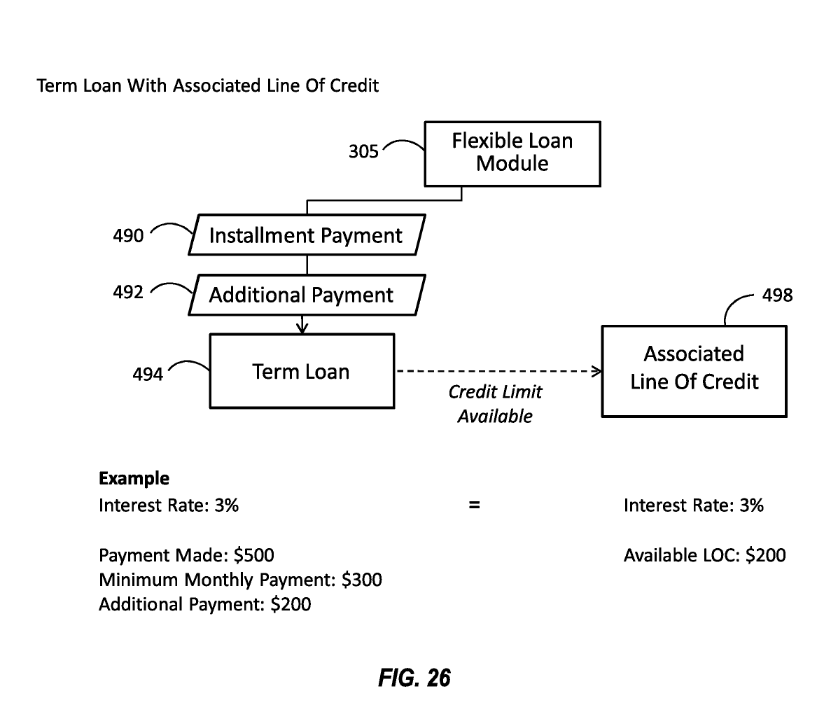

Similarly, FIG. 26 depicts Flexible Loan Module 305 with a term loan 494 and an associated line of credit 498 as another embodiment for the flexible loan with affiliated or attached deposit account. For the term loan 494 with an associated line of credit 498, when an installment payment 490 is made through flexible loan system 300, the minimum installment payment may be applied to term loan 494 and any additional funds paid beyond the minimum installment payment may correspondingly increase associated line of credit 498, which may have the same interest rate as term loan 494. For example, an installment payment of $500 made to term loan 494 at a three percent interest rate with a minimum installment payment of $300 may be allocated as a $300 minimum installment payment to term loan 494 and an additional payment 492 of $200 to associated line of credit 498, which may have a three percent interest rate. Again, in some embodiments, term loan 494 and associated line of credit 498 may have different interest rates. In this example, the extra $200 paid into associated line of credit 498 may be available for the borrower to withdraw much like an available to withdraw balance as described herein for other embodiments.

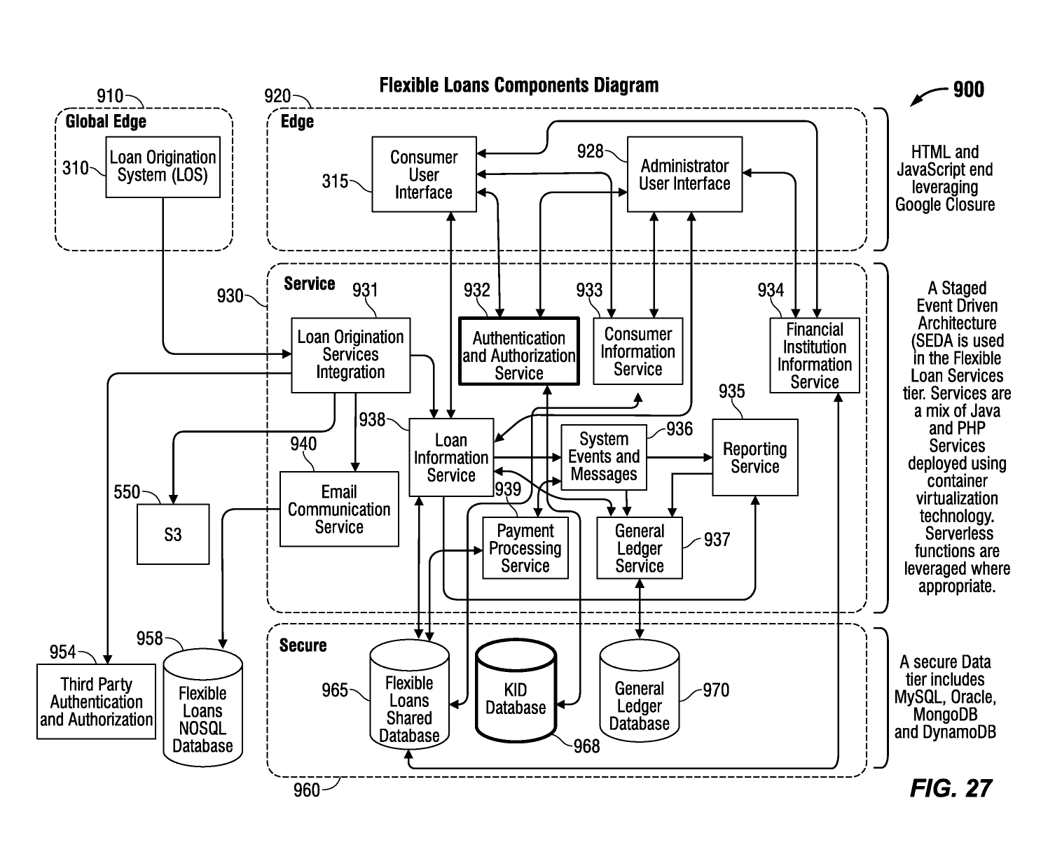

FIG. 27 is a schematic diagram of a components architecture 900, including both process module and apparatus components, some components of which may be included in some embodiments of flexible loan system 300. The components architecture 900 shown in FIG. 27 may be organized into various levels or tiers. For example, individual components of components architecture 900 may be organized between a primary group of tiers 920, 930, and 960 including components directly controlled or managed by a provider of flexible loan system 300. The primary tiers may include edge tier 920, services tier 930, and a secure tier 960 or data tier. Additional tiers 910, 950 may include components that may involve or be managed by different entities from a provider or manager of flexible loan system 300. For example, additional tiers may include global edge tier 910 and global secure tier 950. In some embodiments, components labeled as “third party” components may be directly managed or controlled by a provider of flexible loan 300 and some components in the primary tiers 920, 930, and 960 may be outsourced to one or more other entities or service providers.

Global edge tier 910 may include integration services associated with loan origination system (LOS) 310. In some embodiments, the Loan Origination System 310 may be operated by a third party. In the components architecture 900, integration with the Loan Origination System 310 may be facilitated by loan origination services integration module 931 which may be included in the service tier 930. The global secure tier 950 may include services to support authentication and authorization. The global secure tier 950 may include a third party authentication and authorization module 954. In the components architecture 900, integration with third party authentication and authorization module 954 may be facilitated by authentication and authorization services module 932 which may be included in the services tier 930. In some embodiments, one or more databases, such as NoSQL database 958, may receive, transmit, or store information exchanged between services tier 930 and global secure tier 950. For example, the database 958 may receive information from one or more of loan origination services integration module 931, email communication service module 940, and/or other components of components architecture 900.

Edge tier 920 may include one or more user interface modules which may communicate information to users and/or administrators of flexible loan system 300. For example, edge tier 920 may include flexible loans consumer user interface module 315 and flexible loans administrator user interface module 928. The flexible loans consumer user interface module 315 may power a user interface (UI) that a consumer may interact with. The flexible loans administrator user interface module 928 may power a user interface and associated functionality that an administrator at a financial institution may use in managing flexible loans. Information communicated through edge tier 920 may be provided or controlled by components of the services tier 930 or by other components of components architecture 900. One or more computer programs may be used for visual display or other communication of information within edge tier 920 and over the interfaces 315, 928. For example, in some embodiments, the modules 315, 928 may be programmed using a HTML and Java Script front end leveraging Google Closure. Of course, other architectures and programs may be used, depending on the particular application.

The services tier 930 may include various modules configured to power or control services that may, in some embodiments, be provided using components architecture 900. For example, integration with third party LOS systems may be facilitated by loan origination service integration module 931. Authentication and authorization service module 932 may facilitate user authentication and authorization and communication with third party authentication providers. Consumer information services module 933 may facilitate consumer profile management, consumer level loan details, and interactions with the loan service. Loan information service module 938 may facilitate loan management (e.g., creation, tracking loan transactions and impacts on balance, general ledger update interactions with the general ledger service). General ledger services module 937 may interact with the loan service and update loan balances and handle loan accounting. Financial institution information service module 934 may manage information about a financial institution including, for example, loan product information. Reporting service module 935 may facilitate reporting for a financial institution including, for example, general ledger reporting and periodic reporting. Payment processing service module 939 may facilitate loan payment related functionality at the consumer level and carrying out payments. System events and messages module 936 may transmit messages associated with various events between various modules of components architecture 900. In some embodiments, a staged event driven architecture (SEDA) may be used in the services tier 930. Services may include use of Java, PHP or server-side scripting language services, or both which, in some embodiments, may be employed using container virtualization technologies. In some embodiments, one or more serverless functions may be leveraged where appropriate.

The secure tier 960 may include one or more databases including, for example, a flexible loan shared database 965 and a general ledger database 970. In some embodiments, databases included in secure tier 960 may include one or more database management systems including, for example, MySQL, Oracle, MongoDB, DynamoDB, and any combinations thereof.

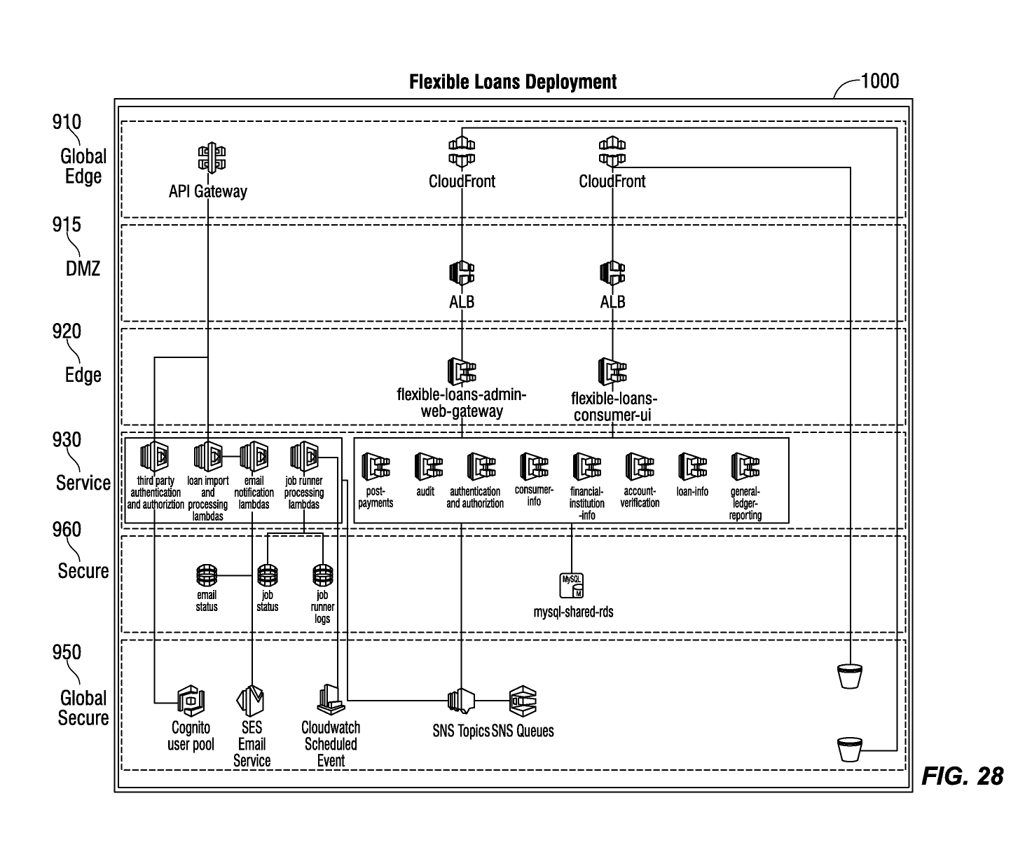

FIG. 28 is a schematic diagram illustrating a group of technologies 1000 that may be used, in some embodiments, to deploy the components architecture 900 included in or together with flexible loan system 300. For example, global edge tier 910 may be deployed using one or more internet services, such as Amazon Web Services (AWS). Accordingly, global edge tier 910 may be employed using publicly accessible components that may reside on infrastructure that may not be controlled by a provider of flexible loan system 300. Components used to deploy components of global edge tier 910 may include static web content, web assets, and API Gateways provided to third party integrators. In some embodiments, components of global edge tier 910 may include HTTP and HTTPS accessible resources.

In some embodiments, deployment of flexible loan system 300 may include use of one or more perimeter networks or demilitarized zones (DMZ) 915. For example, one or more perimeter networks or demilitarized zones 915 may include a logical subnetwork provisioned and controlled by a provider of flexible loan system 300 exposing externally facing components of internally controlled components of components architecture 900 which may interface with the internet or some other untrusted network components. In some embodiments, a flexible loan system 300 may expose only application load balancers (ALBs) in the DMZ 915. In some embodiments, the one or more perimeter networks or demilitarized zones 915 may use an HTTPS secure protocol for data exchange.

In some embodiments, edge tier 920 may be deployed using one or more edge networks containing one or more sanctioned and controlled entry points into the core components of components architecture 900. In some embodiments, systems may place web gateways in the edge tier 920 facilitating application routing and authentication/authorization functions. In some embodiments, edge tier 920 may be deployed using an HTTPS secure protocol for data exchange.

In some embodiments, services tier 930 may be deployed using one or more of programming languages or platforms including, for example, Java, PHP or server-side scripting language services, AWS lambda and combinations thereof. In some embodiments, network segments of services tier 930 may use an HTTPS protocol for data exchange and may only be accessible from components in edge tier 920.

In some embodiments, secure tier 960 may house flexible loan system 300 databases and/or other sensitive resources. In some embodiments, sensitive data in the secure tier 960 may be encrypted and components in secure tier 960 may be selectively or only accessible from the services tier 930.

In some embodiments, global secure tier 950 may provide resources that are secure, but that may not, for example, reside in a virtual provided cloud (VPC) or on a subnetwork provisioned and controlled by a provider of a flexible loan system 300. By way of example, the AWS core components and services may be secured via identity and access management (IAM) security policies. Components used therein may, for example, include Cognito user pools, SES, SNS, SQS, and S3 buckets, or other suitable components may be used.

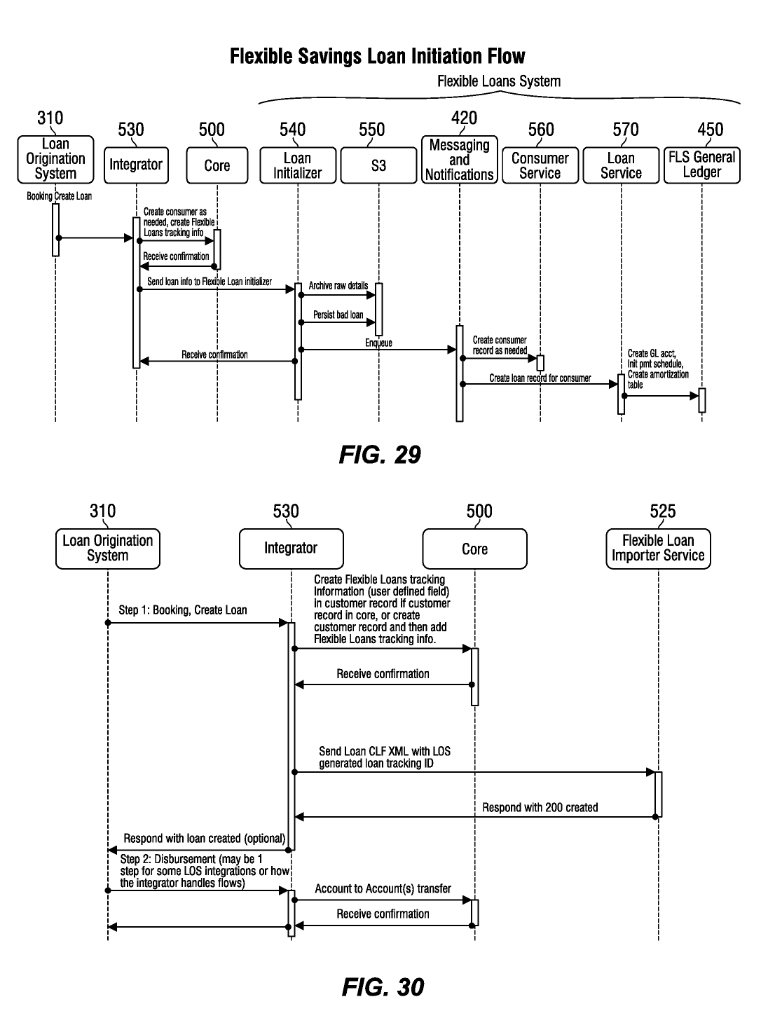

FIG. 29 is a flowchart illustrating some embodiments of flexible savings loan initiation. The flow shows sequences in which instructions may be executed for a flexible loan to be created. In some embodiments, the integrator 530 may be controlled by a third party. The integrator 530 may integrate flexible loan creation and interactions between Loan Origination System 310 and core 500. In some embodiments, core 500 may function as a financial institution's core (FI's Core) banking system. For example, following loan creation in the Loan Origination System 310, the integrator 530 may create consumer and loan tracking information as needed. This information may be sent to the core 500, and following confirmation, loan information may be sent to loan initializer 540. The loan initializer 540 may archive raw details and/or persist any bad loans by sending information to an appropriate storage unit. For example, in some embodiments, loan information may be stored using S3 550, which is an AWS technology, to store data. One or more confirmation messages may further be sent between loan initializer 540 and the integrator 530. Loan initializer 540 may further communicate loan details to messaging & notifications 420. Messaging & notifications 420 may create a consumer record, if needed, and send the record to consumer service module 560. Messaging & notifications 420 may further create a loan record for the consumer and send the record to loan service module 570. Loan service module 570 may perform various functions, including, for example, creation of a general ledger account, initialization of a payment schedule, and creation of an amortization table, and communicate this information to FLS general ledger 450.

FIG. 30 is a flowchart illustrating some embodiments of information exchange between components when importing a flexible loan. As shown in FIG. 30, the loan importing process may start when Loan Origination System 310 creates a loan. In some embodiments, integrator 530 may receive loan information from the Loan Origination System 310 and create or verify the existence of a customer record (if already present in the core 500). The integrator 530 may further create loan tracking information and communicate this information with the core 500. Upon confirmation of the customer record and tracking information, an appropriate confirmation may be sent from the core 500 to the integrator 530. Integrator 530 may then transmit loan information (e.g., LOS generated tracking ID) to a flexible loan importer service 525. The flexible loan importer service 525 may respond with a message to the integrator 530. The integrator 530 may, for example, respond to the Loan Origination System 310 with information about the loan created. FIG. 30 further shows a process for a loan disbursement. For example, in some embodiments, the Loan Origination System 310 may initiate communication between the integrator 530 and the core 500 to initiate one or more account transfers. Confirmation of the one or more account transfers for the disbursement may be sent from the core 500 to integrator 530 and on to Loan Origination System 310.

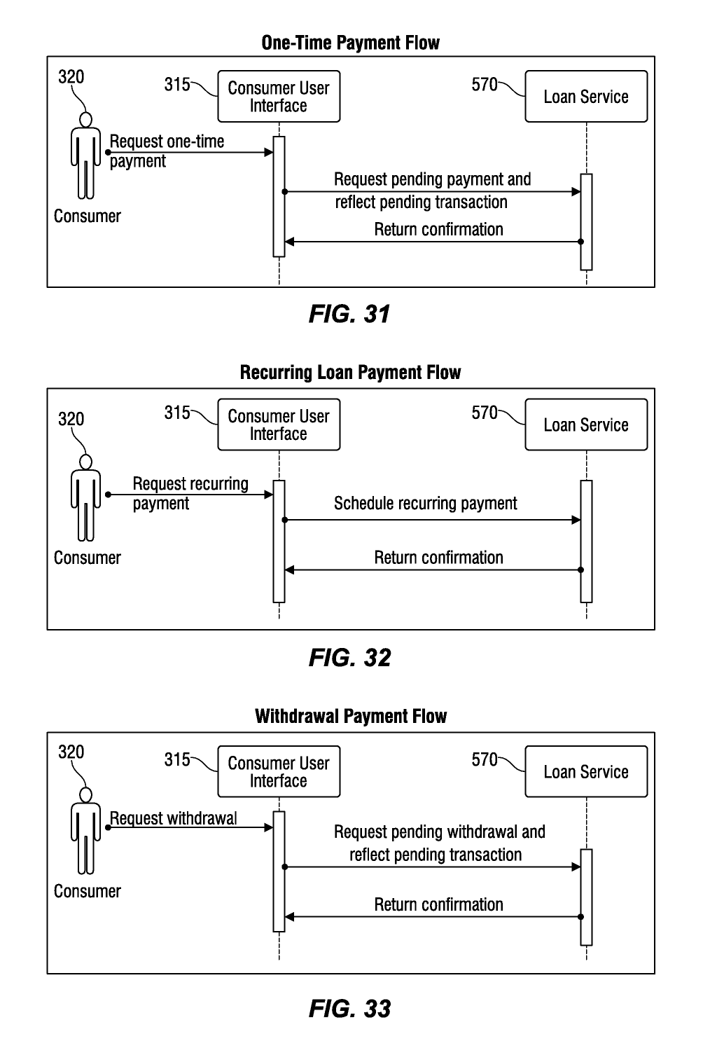

FIG. 31 shows a flowchart illustrating some embodiments of a process for making a one-time payment for a consumer. A consumer 320 may request a one-time payment using a user interface controlled by consumer user interface module 315. A record of the pending payment request and reflecting the pending transaction may be sent to the loan service 570. A return confirmation message may be sent from the loan service 570 for communication to the consumer via consumer user interface module 315.

FIG. 32 shows a flowchart illustrating some embodiments of a process for making a recurring loan payment for a consumer. A consumer 320 may request and schedule a recurring payment with loan service 570 using a user interface controlled by consumer user interface module 315. A return confirmation message may be sent from the loan service 570 for communication to the consumer via consumer user interface module 315.

FIG. 33 shows a flowchart illustrating some embodiments of a process for making a withdrawal payment. A consumer 320 may request a withdrawal using a user interface controlled by consumer user interface module 315. A record of the pending withdrawal and reflecting the pending transaction may be sent from consumer user interface module 315 to the loan service 570. A return confirmation message may be sent from the loan service 570 for communication to the consumer via consumer user interface module 315.

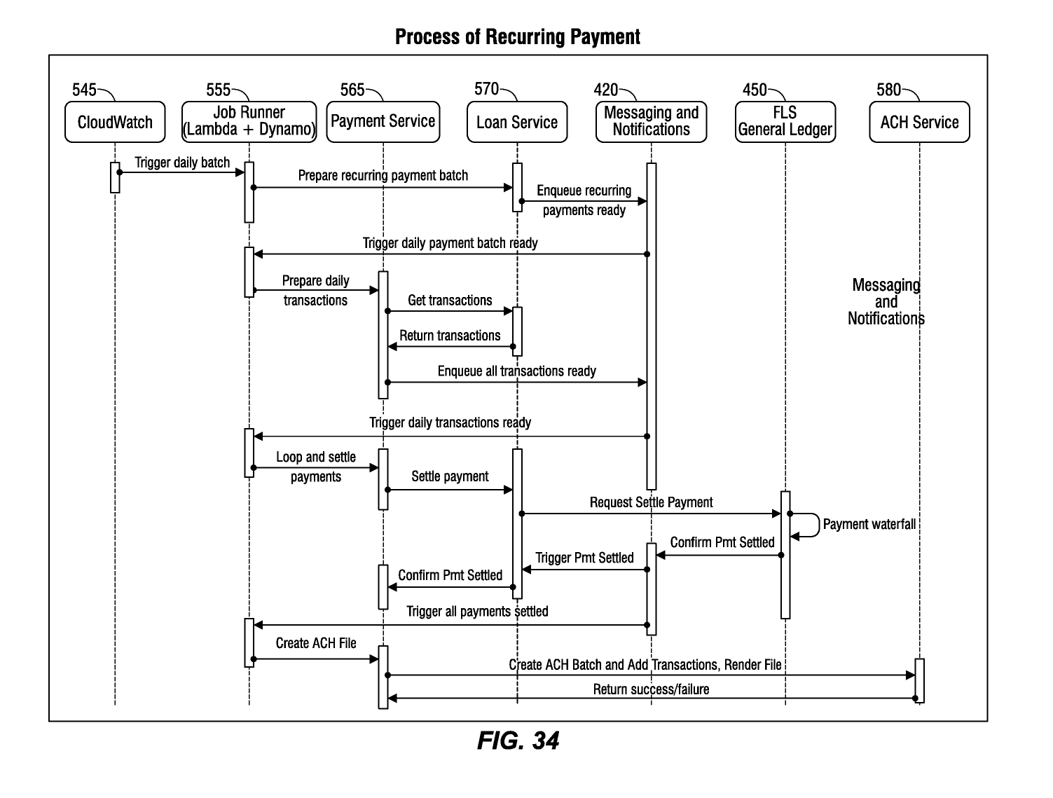

FIG. 34 shows a flowchart illustrating some embodiments of a process for making recurring payments. In some embodiments, a process for initiating recurring payments may include generating a daily batch report or list of scheduled recurring payments. For example, in some embodiments, a daily batch may be triggered using CloudWatch 545 which is a monitoring application for AWS resources. Daily batch triggers may be communicated to job runner module 555 which may be tasked with preparing a recurring payment batch list. In some embodiments, job runner 555 may be configured to operate using AWS lambda and Amazon DynamoDB, for example. The prepared recurring payment batch list or report may then be sent to loan service module 570. The loan service module 570 may interact with messaging & notifications 420 to enqueue recurring payments. Messaging & notifications 420 may then communicate a daily payment batches ready list or trigger message back to the job runner 555. The job runner 555 may accordingly prepare daily transactions and initiate get and return transaction messages between payment service module 565 and loan service module 570. Payment service module 565 may then communicate with messaging & notifications 420 in order to enqueue a list of all ready transactions. Messaging & notifications 420 may then communicate a daily transaction ready trigger to job runner 555. Payments may then be settled, requested, and confirmed as generally shown in FIG. 34 via communications between the job runner module 555, payment service module 565, loan service module 570, messaging & notifications 420, and FLS general ledger 450. Once settled payments are established, an ACH file may be created, such as by the job runner 555, for example. An ACH batch file may then be created and sent from payment service module 565 to ACH service module 580, which may return a success/failure message as appropriate to payment service module 565.

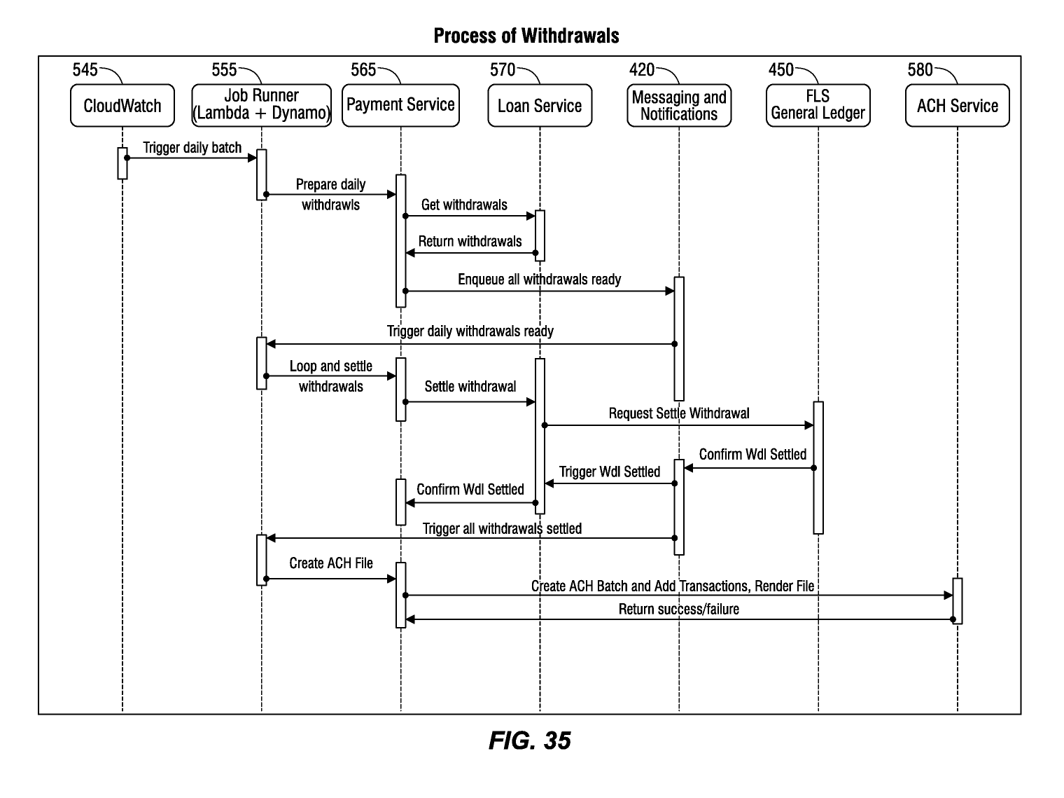

FIG. 35 shows a flowchart illustrating some embodiments of a process for making withdrawals. In some embodiments, processing of withdrawals may include use of a daily batch trigger, such as may be initiated, for example, using CloudWatch service 545. Daily batch triggers may be communicated to job runner module 555. Job runner module 555 may then be tasked with preparing a daily withdrawals list or file and communicating the list or file to payment service module 565. Get and return withdrawals transaction messages may then be exchanged between payment service module 565 and loan service module 570. Payment service module 565 may then communicate with messaging & notifications 420 to enqueue a list of ready withdrawals. Messaging & notifications 420 may then communicate a daily withdrawals ready trigger to job runner 555. Withdrawals may then be settled, requested, and confirmed as generally shown in FIG. 35 via communications between the job runner module 555, payment service module 565, loan service module 570, messaging & notifications 420, and FLS general ledger 450. Once settled withdrawals are established, an ACH file may be created by job runner 555 and sent to payment service module 565. An ACH batch file may be sent from payment service module 565 to ACH service 580, which may return a success/failure message as appropriate to payment service module 565.

The structures and processes disclosed herein may be used with collaboration systems, project management and social systems, including, for example, social networking, asynchronous networks (e.g., “I Follow” types of networks, like Twitter, etc.), synchronous networks (e.g., “I Connect” types of networks), email (Microsoft Exchange, Google Mail, etc.), real time instant messaging (e.g., Persistent Chat, IBM SameTime, etc.), other instant messaging, wiki networks (e.g., Confluence Wiki, etc.) and other product/task systems (e.g., Rational Team Concert, Microsoft Project, etc.). The structures and processes disclosed herein may be used with instant messaging (IM), short message services (SMS), blogs, web sites, communities (such as, for example, LinkedIn and Facebook), news feeds, emails, VoIP, software phones (such as, for example, Skype and Google Voice), etc.

### Exemplary Embodiments

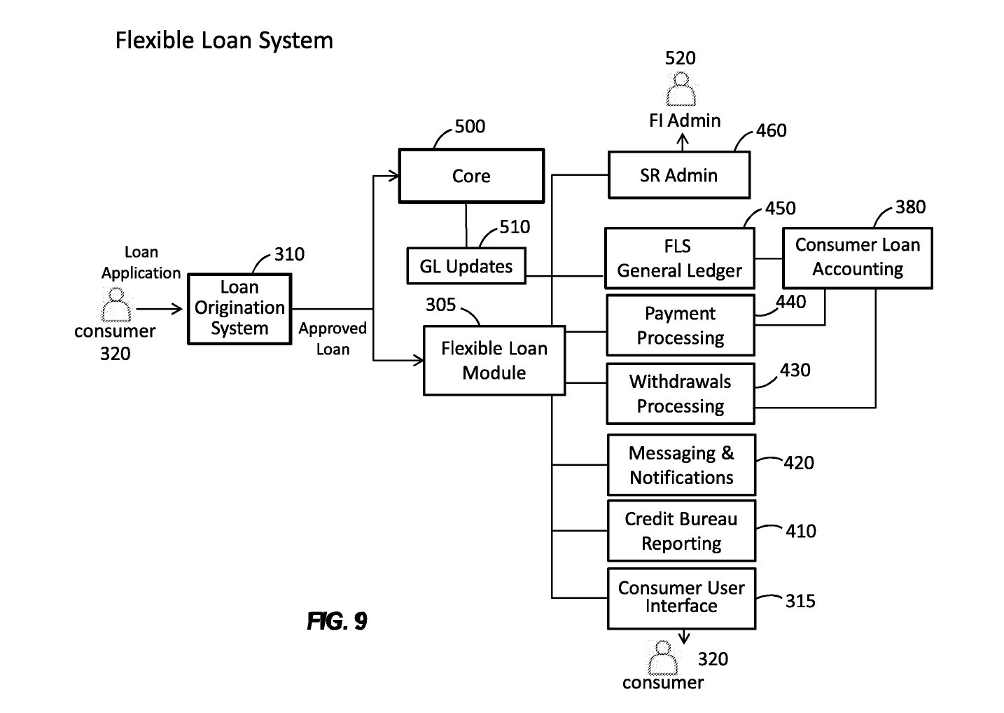

The following description in relation to FIGS. 9-23 pertains to exemplary embodiments of the present invention in which many of the functions are performed by a Flexible Loan System 300 that is operated by or at the direction of a party that is separate from the lender. Such embodiments may be particularly useful in situations in which there is a need or desire to keep existing systems and operations of a lender in place with minimal changes, for example. Persons of ordinary skill in the art will understand, however, that other embodiments may be implemented in which the functions described herein for Flexible Loan System 300 may be included as part of the lender's systems rather than a separate party.

In this description, the following terms should be understood to have the respective meanings stated below.

FI: means financial institution, also referred to as the lender and/or “Funding Source” and may be any entity that provides the funding for a Flexible Loan. The FI may be an institution outside of the Flexible Loan System or may be the entity providing the Flexible Loan System. One or more FI's may provide one or more flexible loans to one or more consumers (borrowers) as described herein.

LOS: refers to the FI's existing loan origination system (LOS). This is the system that the FI uses to gauge the creditworthiness of a borrower and to price a loan based on that creditworthiness.

All Consumer Details: refers to all of the personal information associated with an individual borrower. This may include, but is not limited to: Name, Address, Phone, Email, Birthdate, social security number (SSN), and the like.

All Loan Details: refers to all of the pertinent loan details needed to create and manage a loan. This may include, but is not limited to: Interest Rate, Amount Borrowed, Term, Fees, and the like.

CIF Record: refers to the Customer Information File created on the FI Core processor. The CIF Record may be created so that the FI has a record of each consumer (also referred to as the borrower). Loan documentation created at the time of loan funding may be attached to or made part of the CIF record.

Consumer User Interface or Consumer UI: refers to the GUI that a consumer may interact with in order to manage their flexible loan.

Credit Bureau Reporting: refers to the process of notifying one or more credit bureaus (e.g., Equifax, Transunion, Experian, or other credit bureaus) of the origination and ongoing status of each flexible loan by Flexible Loan System 300 on behalf of the FI.

FI Admin: refers to one or more persons designated by the FI to access individual consumer records and manage back-end support regarding reconciling payments and/or fees in relation to the flexible loans for each consumer.

Core or FI Core: refers to the existing system of record for most (if not all) of the FI's customers and all transactions and balances related to those customers and their respective products. In some embodiments, the consumer and transactional records may reside on the Flexible Loan System 300, not the core 500. Of course, in other embodiments, the consumer and transactional records may reside on the core 500, or both the Flexible Loan System 300 and the core 500.

GL Updates: refers to the process of updating General Ledger (GL) fields on the core 500. Those records may be needed for financial reporting and Call Report purposes. In some embodiments, a Call Report must be filed by all regulated FIs in the U.S. and may contain financial information about the FI including various aggregated loan information such as interest and principal amounts, number of types of loans, etc. In some embodiments wherein the consumer and transactional records reside in Flexible Loan System 300, the GL updates may pass the aggregate information back to the core 500 so that the FI may report accurately to regulators and shareholders, for example.

Flexible Loan System (FLS): refers to the official system of record (Flexible Loan System 300) which stores all individual loan and consumer records. In some embodiments, Flexible Loan System 300 may be owned and/or operated by or at the direction of a party different from the FI and may be external to the core 500.

FLS Operator: refers to the party that operates Flexible Loan System 300, which may or may not be different from the party that operates the LOS and/or the core 500. For example, in some embodiments, one FLS Operator may coordinate flexible loans with multiple FI's.

FLS General Ledger: refers to the General Ledger record-keeping of all flexible loans that reside on the FLS. Individual loan records may be linked in the system to the FI that owns the loan (funded the loan). Aggregate information for each FI may be passed to the core 500 on a daily basis, for example, or other suitable basis, such as real-time or hourly.

Loan Accounting: refers to the accounting and record-keeping of all flexible loans that reside on the FLS, including all transactions and balances for each individual flexible loan.

Messaging & Notifications: refers to the messages and notifications powered and sent by the FLS Operator via the FLS to individual borrowers, on behalf of each respective FI. Messages and notifications may include but are not limited to original enrollment messaging, as well as ongoing communication regarding due dates, payment confirmations, and other required or beneficial communication.

Originating Institution: refers to the entity at which the borrower's deposit account (payment account) resides, and from which the FLS Operator via the FLS may pull money for the purposes of making payments on the applicable flexible loan.

Payments Processing: refers to the process of moving funds from individual borrower deposit accounts to a settlement account at the applicable funding institution, and recording those payments within the FLS and on the FLS General Ledger 450.

Receiving Institution: refers to the entity to which the FLS Operator via the FLS may send borrower payments, which may be the entity from which the borrower's flexible loan was funded, or another entity servicing the flexible loan.

SR Admin: refers to the system that FI representatives may access to view individual consumer and loan records, including transactional history and loan status. In some embodiments in which the consumer and transactional records reside on the FLS, and not the core 500, the SR Admin system 460 may be the only way an FI representative may access individual consumer records.

Tracking Record: refers to a record created on the core 500 which designates that the consumer has a flexible loan as described herein. In some embodiments in which the consumer and transactional records reside on the FLS, and not the core 500, the purpose of the Tracking Record may be to serve as an indication to FI staff that consumer and transactional records for such flexible loans may be found in the SR Admin 460 and not in the core 500.

Withdrawals Processing: refers to the process of moving funds from a designated settlement at the funding institution to individual borrower deposit accounts, and recording those withdrawals within the FLS and on the FLS General Ledger 450.

In some embodiments, flexible loans as described herein may be issued and managed according to a prescribed set of rules. For example, such rules may include the following:

Rule 1: All Payments are Treated Equally

In some embodiments, every payment made to a flexible loan—irrespective of the timing of the payment, the amount of the payment, or where the payment originated from—may be applied to the flexible loan according to a specified payment application order of priority. For example, the following payment application order of priority may be used:
(1) paid to interest accrued;
(2) paid to principal, if any, calculated as the installment amount due for the relevant period minus interest accrued;
(3) paid to fees outstanding, if any;
(4) paid to additional principal, if any.

However, any other suitable order of priority may be used. In some embodiments, the payment application order of priority may be reordered in order to keep the consumer as close to their amortization schedule as reasonably possible.

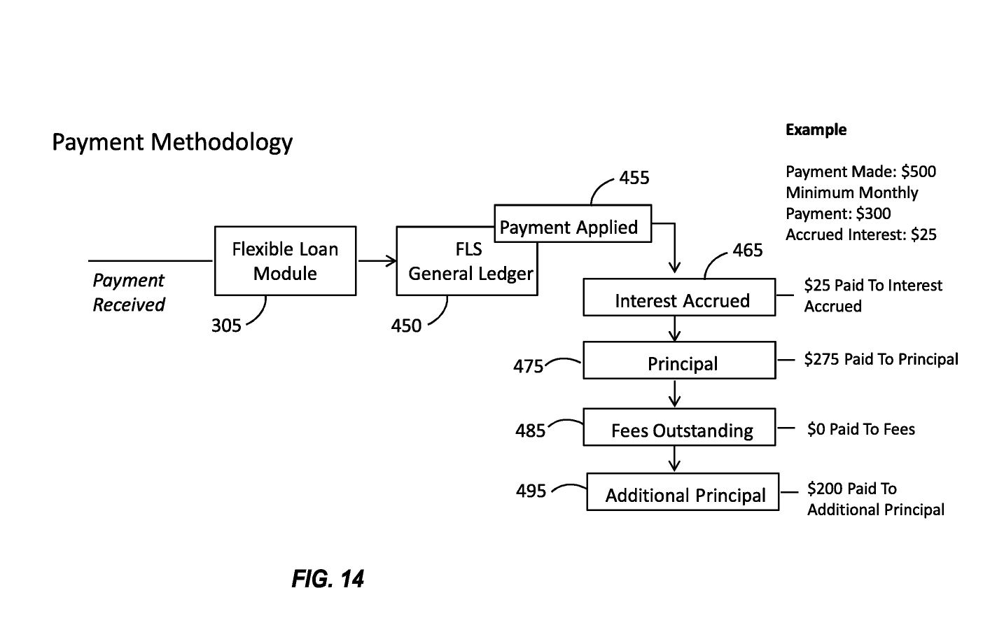

For example, assume Customer Smith has a flexible loan with an outstanding balance of $8,300. As illustrated in FIG. 14, the minimum monthly payment due each period is $300. Customer Smith has not incurred any fees on his flexible loan. Since his last payment 30 days ago, Customer Smith has accrued $25 in interest. Customer Smith makes a payment of $500 on his flexible loan to Flexible Loan Module 305. As indicated at 455, the payment would be applied by FLS General Ledger 450 as follows:
(1) $25 paid to interest accrued (as indicated at 465)
(2) $275 paid to principal=$300−$25 (as indicated at 475)
(3) $0 paid to fees outstanding (as indicated at 485)
(4) $200 paid to additional principal=$500−$300 (amount of payment already applied) (as indicated at 495).

Notably, the application of excess payment amounts to principal in accordance with such a rule stands in stark contrast to previously existing loans in which an extra payment must be specifically designated by the borrower as an extra principal payment. Absent such specific instructions from the borrower, a lender for a previously existing loan would simply apply any excess amount paid by the borrower to the next payment due, which would not help the borrower pay down the debt faster or avoid interest charges. Additionally, the application of payments to interest and principal before any accrued fees as described herein is more favorable to the borrower.

Rule 2: Calculation of Fees and Current/Default Status

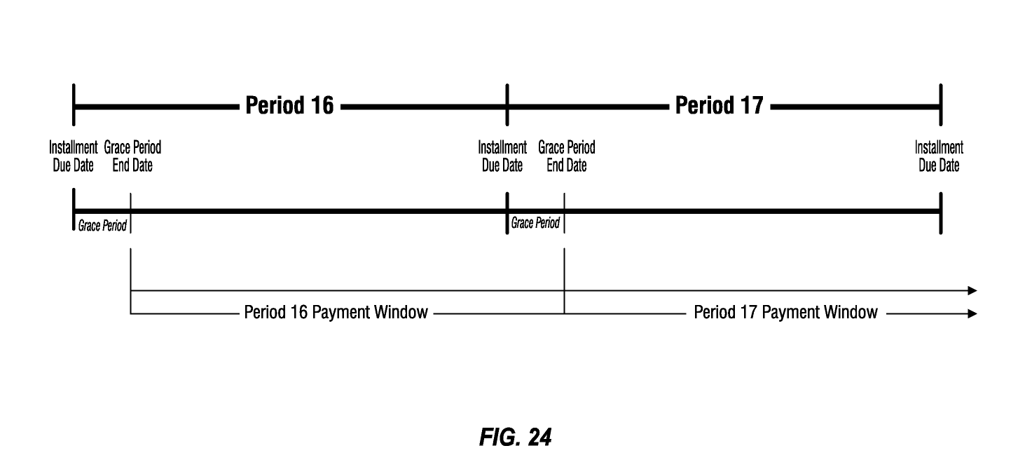

In some embodiments, each borrower that has a flexible loan may be required to satisfy a minimum monthly (or other periodic) payment (sometimes referred to as the installment amount) within each payment period in order to remain current and/or not incur late fees on the loan. The time period in which the borrower must satisfy the installment amount is referred to as the payment window. The payment window, illustrated in FIG. 24, may be defined as the installment due date+the applicable grace period (if any). So long as the total payments made to the flexible loan within each payment window are equal to or greater than the applicable installment amount—irrespective of the number of payments made, the amount of each payment, the allocation among payment categories (interest, principal, fees, extra principal), or where the payments originated from—the borrower will not incur a late fee on the flexible loan.

Notably, this arrangement may have a significant beneficial effect on the consumer's credit score by helping the consumer avoid indications of late payment status to the credit bureaus. By assessing whether the required installment amount has been paid in a given payment window as the relevant criterion for current or default status rather than whether the remaining principal balance is at or below the required amount per the original amortization schedule and/or whether the borrower has paid all accrued interest and fees, the borrower is afforded a much better chance of avoiding late payment status. In some embodiments, each FI may define the relevant requirements for current or default status, and Flexible Loan System 300 may report such status for each borrower to the relevant credit bureaus on behalf of each respective FI.

Rule 3: Calculation of the Available to Withdraw Value

In some embodiments, the available to withdraw value may be defined as the lesser of the following two values:
Calculated Value #1: Difference in Principal Balance=the scheduled outstanding principal balance in the original amortization schedule at a specific time minus the current outstanding principal balance at the same specific time. For example, an amortized scheduled outstanding principal balance on January 10^{th} may be $10,000 with the last scheduled payment made on January 2^{nd}. The current outstanding principal balance may actually be $9,000 on January 10^{th} due to an excess $1,000 payment made with the January 2^{nd} payment. In this example, Calculated Value #1 would be $10,000 less $9,000=$1,000.
Calculated Value #2: Difference in Payments Made to the Loan=the total payments received on the flexible loan minus the total payments expected at a given time according to the original amortization schedule. For example, total payments received as of January 10^{th} may be $5,500. Scheduled payments expected per the original amortization schedule as of January 10^{th} may be $4,000. In this example, Calculated Value #2 would be $5,500 less $4,000=$1,500.

If the lesser of Calculated Value #1 and Calculated Value #2 is a positive amount, the borrower may be permitted to withdraw up to that amount. In the foregoing example, Calculated Value #1 ($1,000) is the lesser of Calculated Value #1 and Calculated Value #2 and is a positive amount, so the available for withdrawal value would be $1,000. In some embodiments, the borrower must be current on the flexible loan to access funds from the available to withdraw balance, and the available to withdraw balance may not be more than the initial loan amount or the amount of principal due at a given point in time per the original amortization schedule. Also, in some embodiments, the borrower may not withdraw funds past the loan's maturity date or after the loan principal is fully paid. The prescribed set of rules for flexible loans may be the same or different from one FI to another. In some embodiments, Flexible Loan System 300 may report the amount available for withdrawal to the relevant credit bureaus, which may also be beneficial to a borrower's credit score.

In some embodiments, to assist borrowers in avoiding negative marks against their credit, Flexible Loan System 300 may automatically apply any amount available for withdrawal if a borrower misses a payment on the flexible loan. Alternatively, a borrower may affirmatively indicate to skip a payment if the borrower has a sufficient available to withdraw balance, and funds from the available to withdraw balance may be applied to cover the skipped payment. As a result, rather than receiving a negative mark against the borrower's credit, the borrower may receive credit for making a payment in the relevant period.

Referring to FIG. 9, a system and method as described herein may permit a consumer 320 to submit a loan application for a flexible loan to a Loan Origination System 310. If the loan application is approved, the approved loan information may be sent from Loan Origination System 310 to Flexible Loan System 300 and core 500. Flexible Loan System 300 may facilitate communication with consumer 320 concerning the flexible loan via a Consumer UI 400. Flexible Loan Module 305 may perform Credit Bureau Reporting 410, Messaging and Notifications 420, Withdrawals Processing 430, Payments Processing 440, and Loan Accounting 470. Flexible Loan Module 305 may also update the FLS General Ledger 450 and perform GL Updates 510 for the core 500. Flexible Loan Module 305 may also facilitate access to flexible loan data by FI Admin 520 via a SR Admin 460.

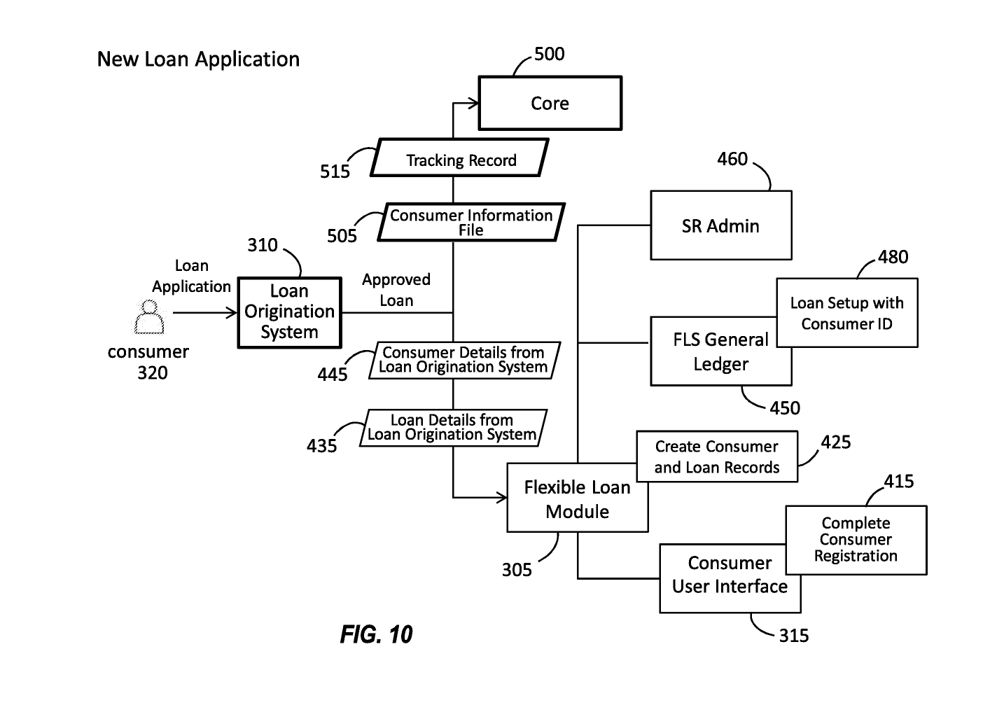

Referring to FIG. 10, once a flexible loan application is approved by Loan Origination System 310, Loan Origination System 310 may send a Consumer Information File 505 and Tracking Record 515 to the core 500. Loan Origination System 310 may also send consumer details from loan origination system (as shown at 445) and send loan details from loan origination system (as shown at 435) to Flexible Loan Module 305. Flexible Loan Module 305 may create consumer and loan records pertaining to the flexible loan as shown at 425 and may complete registration for the consumer as shown at 415. Flexible Loan System 300 may set up the flexible loan in FLS General Ledger 450 with a consumer ID as indicated at 480 and may also facilitate access to flexible loan information by FI staff via SR Admin 460.

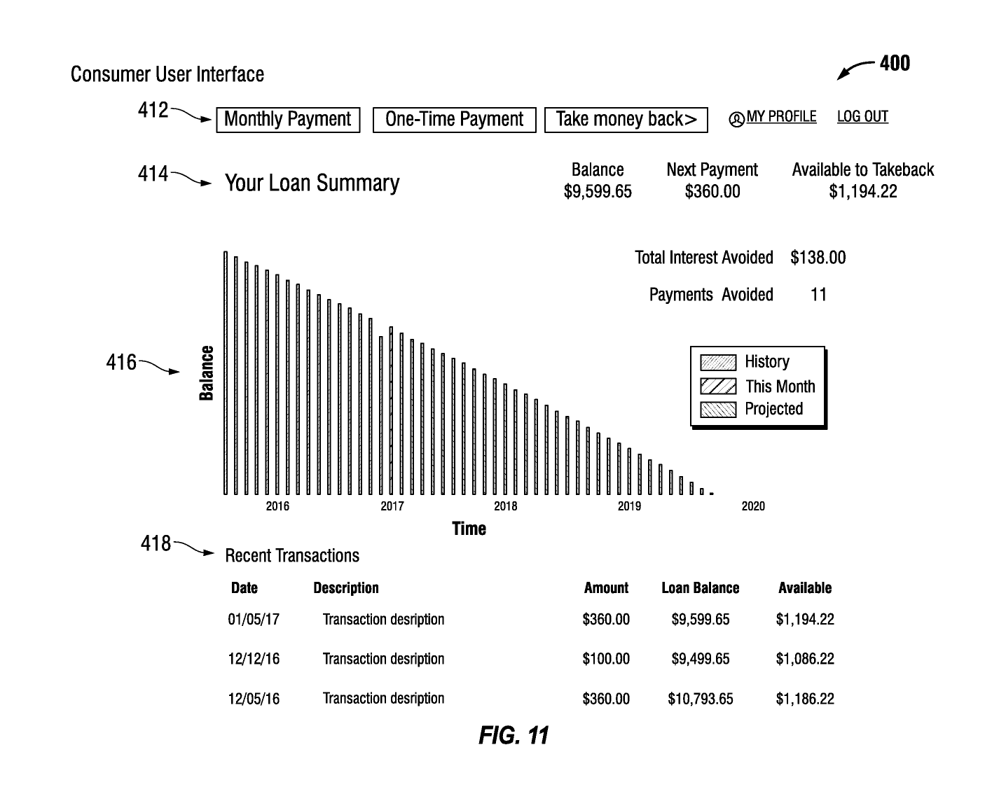

As shown in FIG. 11, user interface 400 may provide alphanumeric and graphical indications of a borrower's flexible loan information. A menu line 412 may provide options for making a monthly payment, making a one-time payment, or making a withdrawal (designated as Take Money Back in this example). A loan summary line 414 may provide information including but not limited to the current balance, next payment amount, and amount available to take back (withdraw). A payment history and projection graph 416 may graphically indicate the original amortization schedule, payment history, current payment, and projected payments for the remainder of the loan term. Total interest avoided and payments avoided may also be indicated. A recent transactions chart 418 may indicate date, description, amount, loan balance, and available withdrawal balance as of recent transactions with respect to the flexible loan.

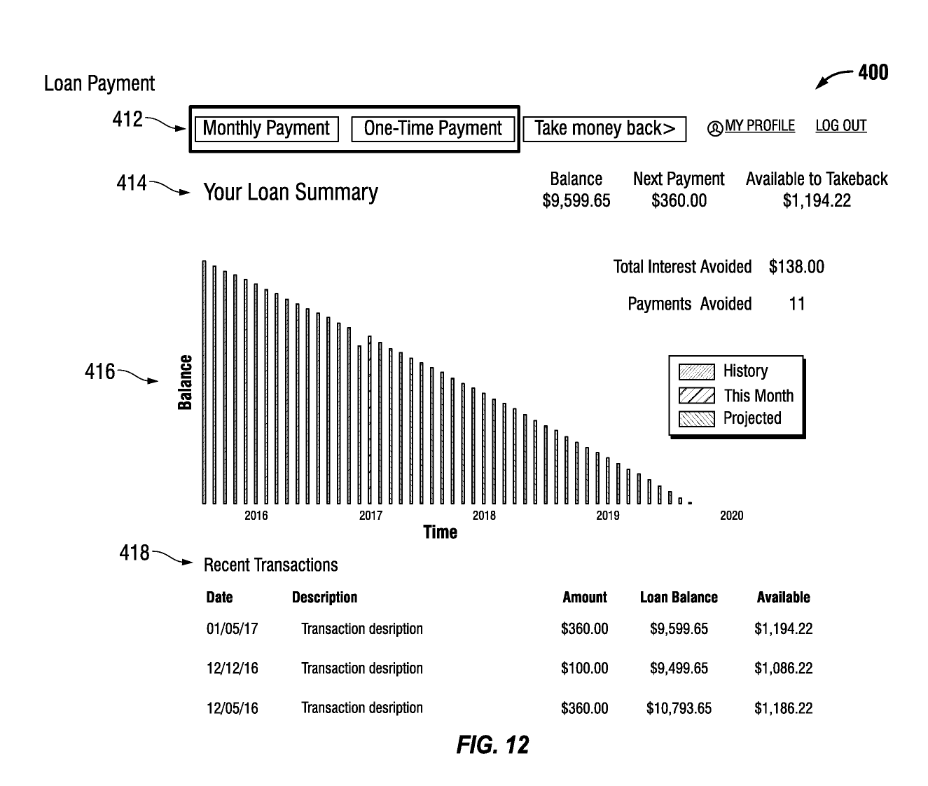

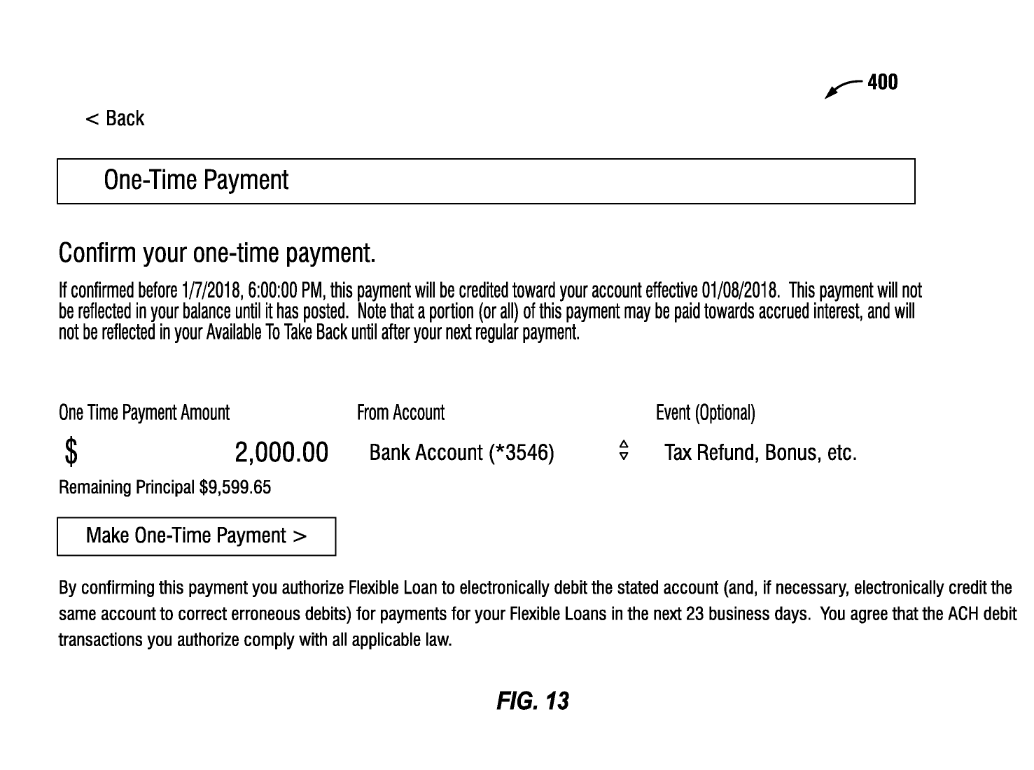

Referring to FIGS. 12 and 13, if a consumer selects a one-time payment from menu line 412, user interface 400 may provide a screen to allow the consumer to enter or select the desired payment amount and relevant account and confirm the one-time payment. When received by Flexible Loan Module 305, the payment may be applied as discussed above in connection with FIG. 14.

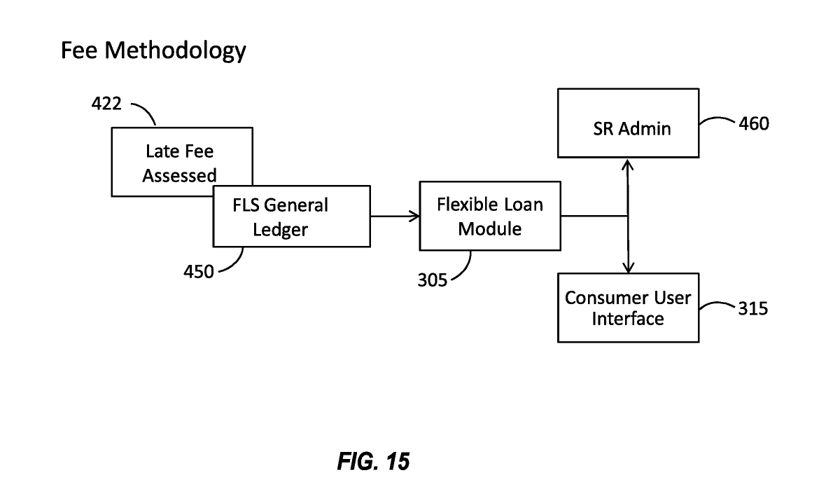

Fees may be assessed and managed as shown in FIG. 15. For example, if a late fee is assessed as indicated at 422, the fee may be reflected in FLS General Ledger 450, and Flexible Loan Module 305 may communicate the fee information to the consumer via Consumer UI 400 and to the FI via SR Admin 460.

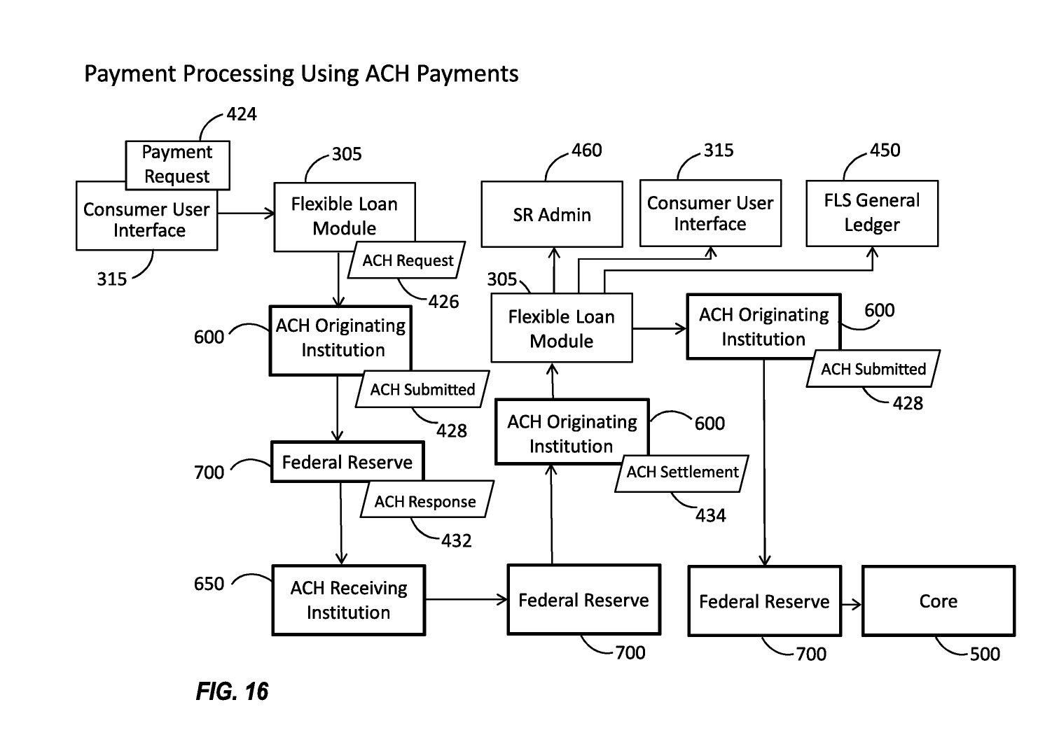

In some embodiments, payments made on a flexible loan may be processed as shown in FIG. 16 via the Automated Clearing House (ACH), for example. A borrower may make a payment request 424 to Flexible Loan Module 305 via Consumer UI 400. In response to the payment request 424, Flexible Loan Module 305 may generate a corresponding ACH request 426 and submit it to the ACH originating institution 600, which in turn may submit the request to the Federal Reserve 700 as shown at 428. In response to receipt of the payment request, Federal Reserve 700 may generate and send an ACH response 432 to the ACH receiving institution 650, which in response may send instructions for settlement to the Federal Reserve 700. In response, Federal Reserve 700 may send an ACH settlement 434 to the ACH originating institution 600, which in response may send settlement instructions to Flexible Loan System 300. In response, Flexible Loan Module 305 may coordinate payment with the ACH originating institution 600, which may submit an ACH payment 436 to the Federal Reserve 700, which in response may send payment confirmation to the core 500. Flexible Loan Module 305 may update the FLS General Ledger 450 to reflect the payment, and Flexible Loan Module 305 may communicate such payment confirmation to the consumer via Consumer UI 400 and to the FI via SR Admin 460.

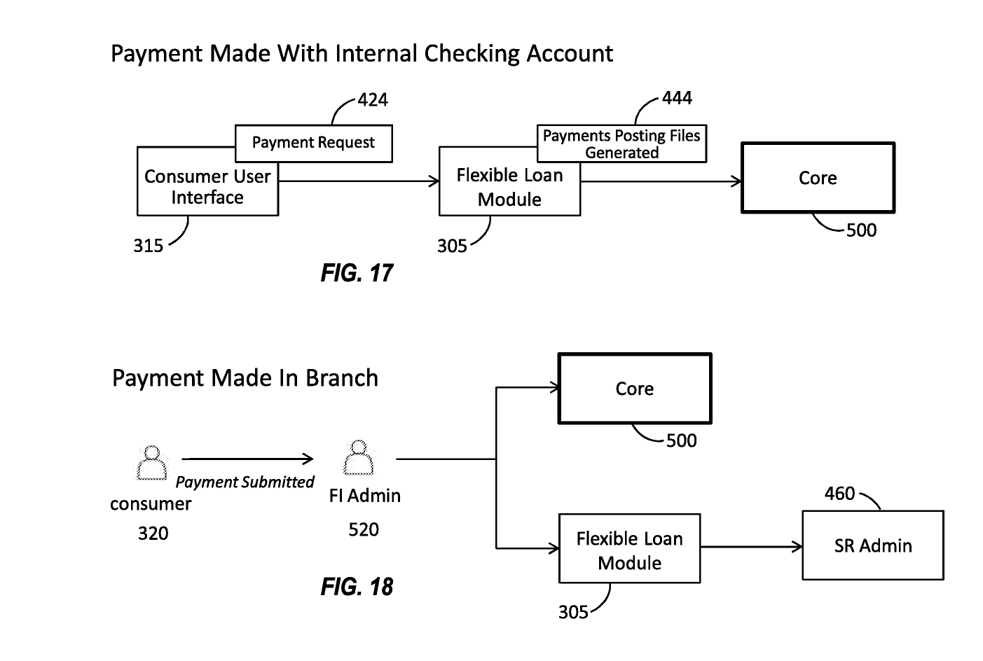

As shown in FIG. 17, to make a payment on a flexible loan via an internal checking account, a consumer may make a payment request 424 to Flexible Loan Module 305 via the Consumer UI 400. Flexible Loan Module 305 may post the files generated by the payment request to the core 500 as shown at 444. For example, one or more Payments Posting Files may be generated.

Alternatively, as shown in FIG. 18, a consumer 320 may make a payment on a flexible loan in a branch of the relevant FI via FI Admin 520. The payment may be reflected in Flexible Loan Module 305 and core 500.

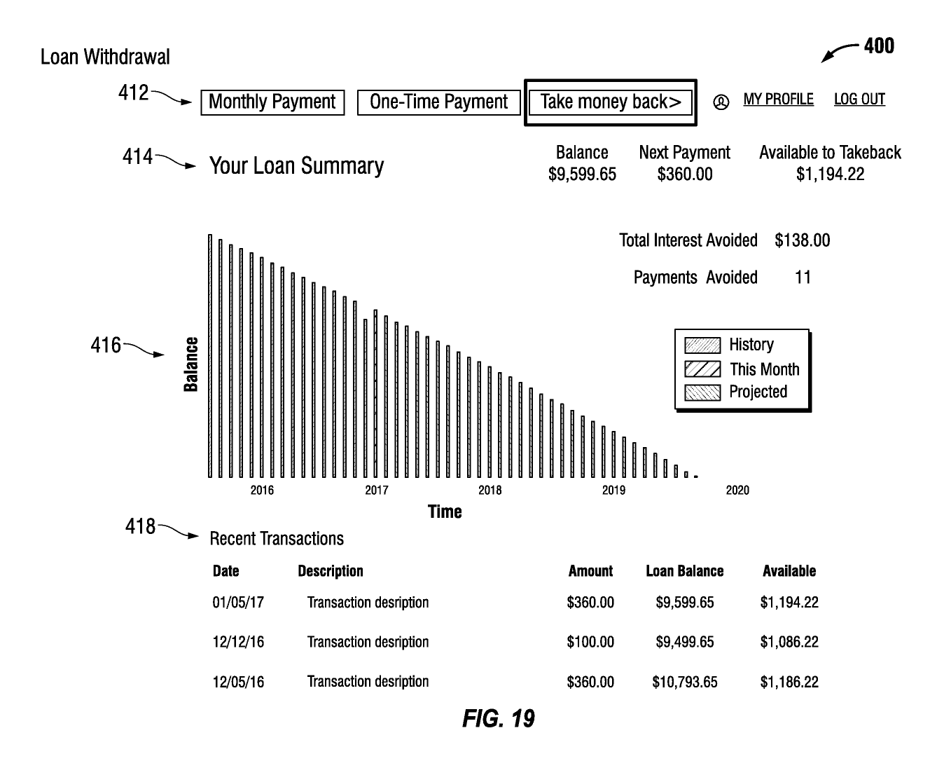

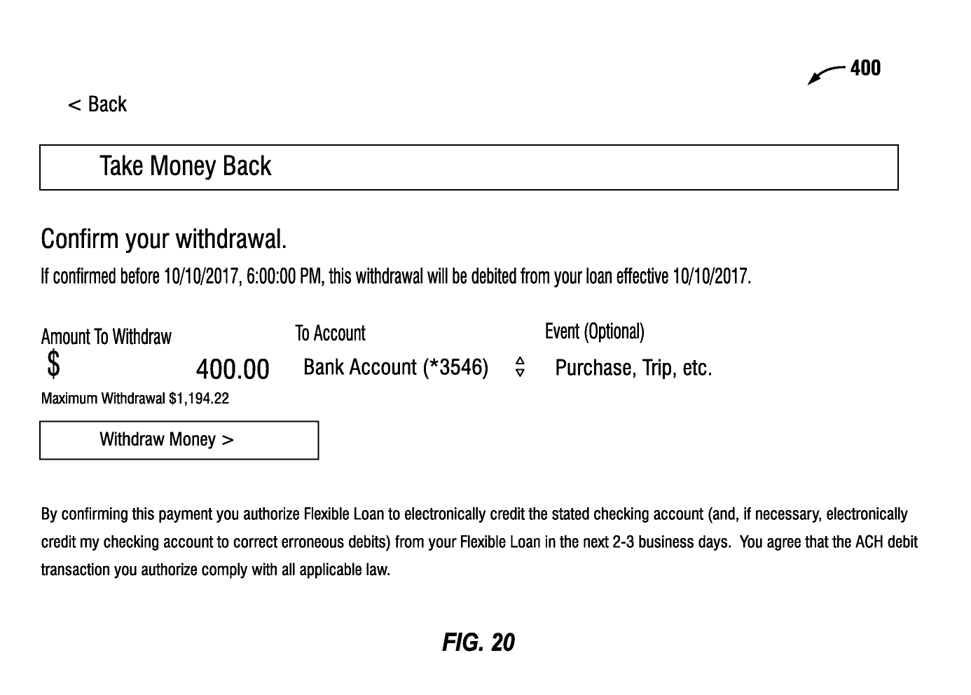

As shown in FIG. 19, a consumer may select to make a withdrawal (take money back) in menu line 412 of Consumer UI 400. In response to the selection, Consumer UI 400 may provide a screen as shown in FIG. 20 to allow the consumer to confirm such withdrawal request. The consumer may indicate the amount of the withdrawal and relevant account information, for example, as shown in FIG. 20.

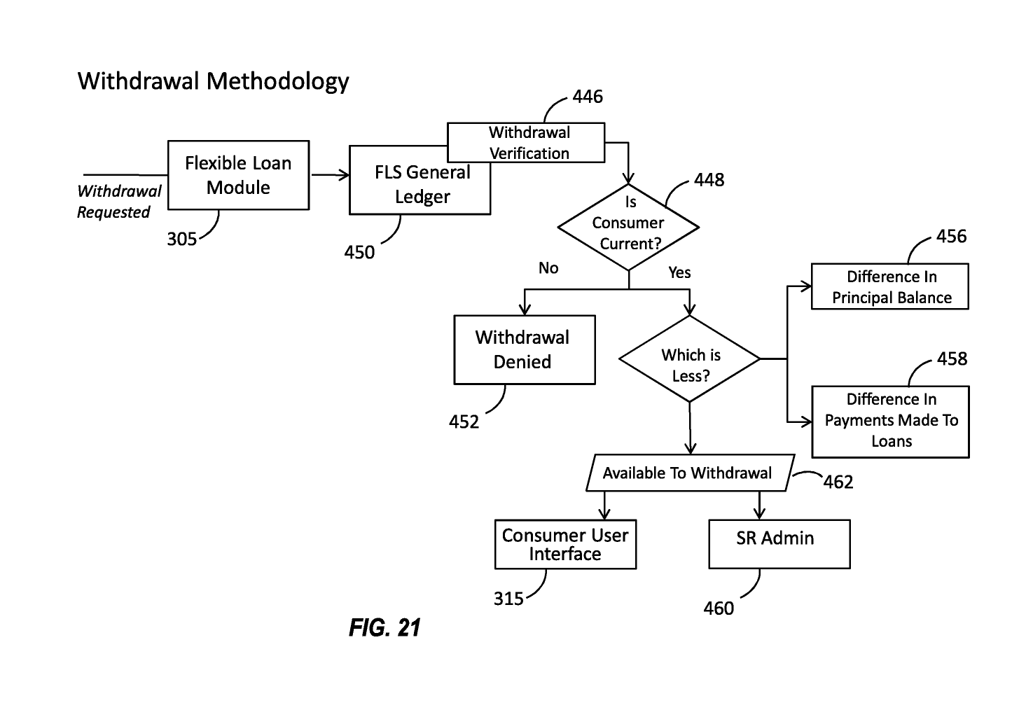

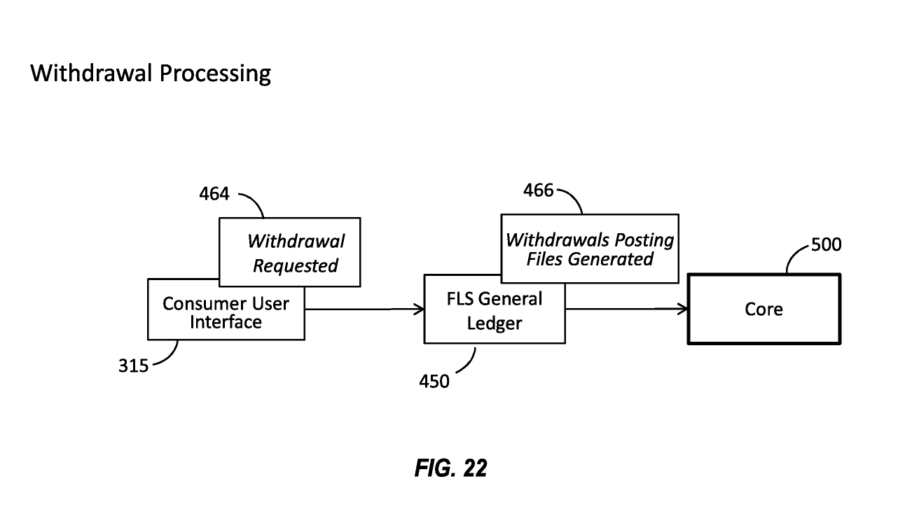

A withdrawal request may be processed as shown in FIG. 21. Upon receipt of a withdrawal request from a consumer 320, Flexible Loan Module 305 may verify whether the withdrawal request may be granted as shown at 446 in coordination with FLS General Ledger 450. Specifically, Flexible Loan Module 305 may determine whether the borrower is current on his or her flexible loan as shown at 448. If the borrower is not current, the withdrawal request may be denied as shown at 452. If the borrower is current, Flexible Loan Module 305 may determine the lesser of Calculated Value #1 (Difference in Principal Balance) and Calculated Value #2 (Difference in Payments Made to the Loan) as discussed above and indicated at 456 and 458, respectively. The lesser of those two values may be designated as the available to withdraw amount as shown at 462, which may be communicated to consumer 320 and the relevant FI via Consumer UI 400 and SR Admin 460, respectively. As shown in FIG. 22, FLS General Ledger 450 may post files generated in response to a withdrawal request 464 entered via Consumer UI 400 to the core 500 as indicated at 466. For example, one or more Withdrawals Posting Files may be generated.

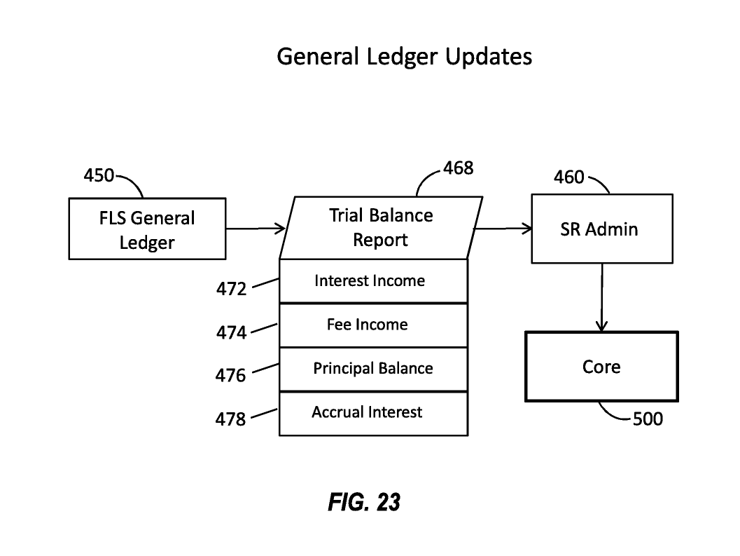

Flexible Loan System 300 may process GL updates for transactions made with respect to flexible loans described herein as shown in FIG. 23. Specifically, FLS General Ledger 450 may generate a daily (or other periodic) balance report showing interest income 472, fee income 474, principal balance 476, and accrued interest 478 for each flexible loan and in the aggregate for all flexible loans associated with a given FI, and such information may be communicated to core 500 via SR Admin 460.

Persons of ordinary skill in the art will appreciate that a flexible loan as described herein may effectively function as both an installment loan and a savings account from which approved withdrawals may be made, all within the context of a single loan account using a single loan documentation. This stands in stark contrast to previously existing loan accounts, which would require a whole new account with additional loan disclosure documentation in order to allow a consumer to withdraw excess funds resulting from payments the consumer made over the required payment amounts. In previously existing loan accounts, such a change to permit withdrawal of excess funds would change the risk profile of the loan, whereas a flexible loan as described herein may retain the same risk profile due to both the installment loan and savings account features being included in one account with a single loan documentation. Additionally, flexible loan systems and methods described herein may illustrate to the consumer the effects of making extra payments or withdrawing excess amounts before making such transactions. In some embodiments, the illustration of such effects may include not only changes to the payoff date and overall interest avoided but also the effect on the consumer's credit score. As such, a flexible loan as described herein may encourage borrowing, saving, and attendant improvements to a consumer's credit score. In some embodiments, a flexible loan as described herein may allow a consumer who would not otherwise have access to credit to receive credit and build a credit score. Systems and methods for flexible loans as described herein may show a consumer how paying more than the minimum payment amount may help the consumer save money by avoiding interest charges. Such systems and methods may also be beneficial to FI's by allowing them to take advantage of additional revenue streams from such consumers while minimizing operational and accounting changes to the FI's existing loan origination systems and accounting systems. Additionally, unlike existing loan systems and methods, in some embodiments described herein, the GL updates to a FI's GL may include detailed account information (e.g., all transaction data and balance information) for each flexible loan associated with a given FI, not merely an aggregate balance of all such loans.

Also, in some embodiments described herein, interest on the outstanding principal balance may be computed daily, which is in contrast to average daily interest computed in retrospect according to existing systems and methods. For example, in some embodiments, the system may calculate interest on the flexible loan by applying the daily periodic rate to the daily balance of the account for each day in a billing cycle. To compute the daily balance, the system may start with the beginning balance of the account each day, add any new loan advances and subtract any payments or credits made to the account, to yield the daily balance. The daily interest may be computed by applying the applicable daily periodic rate to each daily balance for the billing cycle. All the daily interest amounts for each day in the billing cycle may be totaled to compute the total interest for the billing cycle. The applicable daily periodic rate may be determined by dividing the annual percentage rate by 365. In this way, interest may be accrued and paid only to the date the payment is made and applied to the FLS. This is in contrast to customary scheduled payment loans, which compute the interest based on the scheduled payment date such that interest is accrued and due based on that scheduled payment date, not the actual date the payment is made, which results in additional interest accrued and paid over the life of the loan.

In some embodiments, the unique construction of a flexible loan as described herein may allow for each loan to be disassembled and its various parts split and shared amongst multiple investors, all while maintaining a unified and consistent experience to the borrower. Likewise, given the unique construction of Flexible Loan System 300, loans may be booked and funded from any institution within the network, and the servicing and maintenance of any loan may be held at a separate institution.

While existing solutions may allow for a loan to be divided amongst multiple investors, none allow the loan to be split in such a way that it results in two entirely different asset types. For example, with traditional loan securitization, the division of a term loan amongst multiple investors would result in each investor owning a piece of a closed-end installment loan. With a flexible loan as described herein, in some embodiments, the loan may be divided such that investors may own a piece of a traditional closed-end loan or a piece of an open-end line of credit, and either investor may or may not own the servicing rights associated with the loan.

In some embodiments, a flexible loan as described herein may be kept as one account from the borrower's standpoint yet it may be split up into an installment loan portion and an available for withdrawal portion from an investor standpoint. For example, the installment loan portion of one or more flexible loans as described herein may be held by a first investor or group of investors (e.g., the one or more FI's that originally made the flexible loans), and the available for withdrawal portion of one or more flexible loans as described herein may be held by a second investor or group of investors (e.g., one or more persons or institutions that may or may not include the one or more FI's that originally made the flexible loans). Thus, flexible loan systems and methods as described herein may effectively create a new secondary market for the available for withdrawal portions of flexible loans which has never before existed. Furthermore, the party holding the servicing rights associated with the flexible loan may or may not be the same as the first or second investor (or group of investors). In some embodiments, each borrower may make payments on his or her flexible loan to Flexible Loan System 300 as described herein, and Flexible Loan System 300 may allocate and pass along the appropriate portions of such payments to the applicable investors. This arrangement may allow FI's, for example, to make more interest revenue than is customary under current banking practices.

In some embodiments, the Flexible Loan System 300 may serve as the primary loan servicing engine for all flexible loans issued by lenders in a flexible loans network in communication with Flexible Loan System 300. As such, Flexible Loan System 300 may handle the processing, application, and recording of all payments and withdrawals made against the flexible loans. The Flexible Loan System 300 may also serve as the official record for individual loan balances and borrower status, as well as the official record of primary and secondary ownership positions pertaining to each flexible loan. Data processed and stored on the Flexible Loan System 300 may be used to power the Consumer UI 400, which is an innovative tool that may provide borrowers increased transparency regarding their flexible loans and may allow borrowers to manage their flexible loans online, for example.

While this specification contains many specifics, these should not be construed as limitations on the scope of the invention or of what can be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Those skilled in the art having read this disclosure will recognize that changes and modifications may be made to the embodiments without departing from the scope of the present invention.

It should be appreciated that the particular implementations shown and described herein are illustrative of the invention and its best mode and are not intended to otherwise limit the scope of the present invention in any way. Other variations are within the scope of the following claims.

The actions recited in the claims can be performed in a different order and still achieve desirable results. Likewise, the processes depicted in the accompanying figures do not necessarily require the particular order shown, or sequential order, to achieve desirable results. In certain implementations, multitasking and parallel processing can be advantageous.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims.

As used herein, the terms “comprises,” “comprising,” “including,” “having,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as essential or critical.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Access to information using systems and methods described herein may be via touch, sight, hearing, or any combination thereof.

“Computer” means any programmable machine capable of executing machine-readable instructions. A computer may include but is not limited to a general purpose computer, microprocessor, computer server, digital signal processor, or a combination thereof. A computer may comprise one or more processors, which may comprise part of a single machine or multiple machines.

The term “computer program” means a list of instructions that may be executed by a computer to cause the computer to operate in a desired manner.

The term “computer readable medium” means a tangible, non-transitory article of manufacture having a capacity for storing one or more computer programs, one or more pieces of data, or a combination thereof. A computer readable medium may include but is not limited to a computer memory, hard disk, memory stick, magnetic tape, floppy disk, optical disk (such as a CD or DVD), zip drive, or combination thereof.

“GUI” means graphical user interface.

“Interface” means a portion of a computer processing system that serves as a point of interaction between or among two or more other components. An interface may be embodied in hardware, software, firmware, or a combination thereof.

“I/O device” may comprise any hardware that can be used to provide information to and/or receive information from a computer. Exemplary I/O devices may include disk drives, keyboards, video display screens, mouse pointers, joysticks, trackballs, printers, card readers, scanners (such as barcode, fingerprint, iris, QR code, and other types of scanners), RFID devices, tape drives, touch screens, cameras, movement sensors, network cards, storage devices, microphones, audio speakers, styli and transducers, and associated interfaces and drivers.

“Memory” may comprise any computer readable medium in which information can be temporarily or permanently stored and retrieved. Examples of memory include various types of RAM and ROM, such as SRAM, DRAM, Z-RAM, flash, optical disks, magnetic tape, punch cards, EEPROM, and combinations thereof. Memory may be virtualized, and may be provided in or across one or more devices and/or geographic locations, such as RAID technology, for example.

The corresponding structures, materials, acts, and equivalents of all means or step plus function elements in the claims below are intended to include any structure, material, or act for performing the function in combination with other claimed elements as specifically claimed.

The description of embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Among other things, although some embodiments have been described as having certain “modules,” some embodiments may not be structured in terms of modules. For example, in some embodiments, functionality represented as modules within flowcharts and block diagrams may be implemented by hardware, software, firmware, or any combination thereof, and such functionality may or may not be grouped together within the same portion thereof.

1. A flexible loan system comprising:
a processor and a memory in communication with said processor, said processor comprising a flexible loan module configured to receive consumer loan data for a consumer loan for a consumer from a loan origination system, said consumer loan data including a principal loan amount and payment terms including a payment schedule;
said processor further comprising a consumer loan transaction module configured to receive transaction data from the consumer including a request to modify the payment terms of the consumer loan;
said processor further comprising a consumer interface module configured to provide said consumer loan data for display on a visual display for the consumer and receive one or more modifications of said consumer loan data from the consumer; and
said flexible loan module being further configured to provide modified consumer loan data representative of said one or more modifications to the consumer interface module suitable for display on the visual display in real time so that the visual display may depict a visual representation of the modified consumer loan data before said payment terms are modified.

2. The system of claim 1, wherein said visual representation further comprises a visual representation of the modified consumer loan data in terms of principal versus length of term.

3. The system of claim 1, wherein said flexible loan system is accessible by the consumer remotely.

4. The system of claim 1, wherein said transaction data comprises a request for withdrawing an available to withdraw balance from the consumer loan.

5. The system of claim 1, wherein said transaction data comprises a request for modifying the payment amount of the consumer loan.

6. The system of claim 1, wherein said visual representation comprises a visual representation of the consumer loan data and the modified consumer loan data in one image.

7. The system of claim 1, wherein said visual representation further comprises a visual representation of the modified consumer loan data in terms of total interest avoided and payments avoided.

8. A flexible loan system comprising a tangible, non-transitory computer readable medium comprising instructions executable by a computer for performing the following:
receiving loan data pertaining to a flexible loan from a funding source to a consumer, said loan data comprising an original principal amount, an original periodic payment amount, an original term, and an original payoff date;
receiving periodic payment amounts to be applied to said flexible loan;
adjusting a remaining principal amount for said flexible loan based on said periodic payment amounts;
displaying a first representation of said flexible loan for said consumer, said first representation comprising
a representation of an original payment schedule for said flexible loan over said original term, including a representation of said original payoff date,
a representation of a current date,
a representation of a payment history for said flexible loan through said current date, and
a representation of said remaining principal amount through a currently applicable payoff date;
receiving from said consumer a first indication of a potential change to said flexible loan, said potential change being withdraw money;
calculating an excess amount by which one or more payments made by said consumer on said flexible loan exceed a minimum payment amount;
receiving a request from said consumer for a withdrawal in an amount less than or equal to said excess amount; and
displaying a second representation of said flexible loan for said consumer, said second representation reflecting a change to at least one of said remaining principal amount and said currently applicable payoff date, said second representation illustrating said change versus said first representation;
receiving from said consumer a second indication to make said potential change effective;
authorizing said withdrawal in response to said request; and
modifying said flexible loan in response to said second indication.

9. The flexible loan system of claim 8 wherein at least one of said first and second representations of said flexible loan comprises a declining graphical representation of said remaining principal amount from said current date to said currently applicable payoff date.

10. The flexible loan system of claim 8 wherein said first and second representations are displayed in a common image.

11. The flexible loan system of claim 10 wherein said first and second representations are displayed in an overlayed manner.

12. A method for providing a flexible loan to a consumer, comprising:
receiving consumer loan data for a flexible loan from a remote location and storing said consumer loan data;
providing the consumer with access to the flexible loan through a user interface which provides a visual representation of the consumer loan data;
providing the consumer with an option to indicate a modification to the flexible loan through said user interface;
generating a visual representation of said modification via said user interface in real time; and
incorporating said modification into said flexible loan only if said modification is authorized by the consumer.

13. The method of claim 12, further comprising:
providing the consumer with an option to make a withdrawal of money from the flexible loan in an amount that does not exceed a calculated amount of overpayment at the time of said withdrawal.

14. The method of claim 12, further comprising:
providing the consumer with an option to modify a payment amount of the flexible loan.

15. The method of claim 12, further comprising:
providing a graphical representation of the consumer loan data and said modification to the consumer loan data in one image.

16. The method of claim 13, further comprising:
providing a graphical representation of the consumer loan data and said modification to the consumer loan data in one image.

17-30. (canceled)
